(19) United States
(12) Patent Application Publication
(10) Pub. No.: US 2015/0097931 A1
(43) Pub. Date: Apr. 9, 2015

(54) CALIBRATION OF 3D SCANNING DEVICE

(71) Applicant: United Sciences, LLC., Atlanta, GA (US)

(72) Inventors: Karol Hatzilias, Atlanta, GA (US); Harris Bergman, Marietta, GA (US); Ruizhi Hong, Roswell, GA (US); Giorgos Hatzilias, Buford, GA (US); Jon Jowers, Atlanta, GA (US); Wess Eric Sharpe, Atlanta, GA (US)

(21) Appl. No.: 14/049,518

(22) Filed: Oct. 9, 2013

(51) Int. Cl. H04N 17/00; H04N 13/02

(52) U.S. Cl. CPC H04N 17/002; H04N 13/0221
USPC 348/50

(57) ABSTRACT

Various examples related to calibration of a scanning device are disclosed. In one example, among others, a system includes a calibration pattern, a sensing device, and a calibration control system to control positioning of the calibration pattern with respect to the sensing device. Tracking sensors of the sensing device capture images of the calibration pattern during calibration of the sensing device. In another example, a method includes determining an estimated pose of the scanning device using an image of a calibration pattern, determining an error between a projected location of an artifact of the calibration pattern and an actual location of the artifact, and adjusting a tracking parameter using the error. In another example, a method includes determining an association between a pixel of an image sensor of a scanning device and a point in scanner space using pixel information corresponding to light reflected by an illuminated calibration pattern.

### CROSS REFERENCE TO RELATED APPLICATIONS

This application is related to U.S. patent application Ser. No. ______, filed on Oct. ______, 2013 (Attorney Docket No. 52105-1010) and entitled “Tubular Light Guide,” U.S. patent application Ser. No. ______, filed on Oct. ______, 2013 (Attorney Docket No. 52105-1020) and entitled “Tapered Optical Guide,” U.S. patent application Ser. No. ______, filed on Oct. ______, 2013 (Attorney Docket No. 52105-1030) and entitled “Display for Three-Dimensional Imaging,” U.S. patent application Ser. No. ______, filed on Oct. ______, 2013 (Attorney Docket No. 52105-1040) and entitled “Fan Light Element,” U.S. patent application Ser. No. ______, filed on Oct. ______, 2013 (Attorney Docket No. 52105-1050) and entitled “Integrated Tracking with World Modeling,” U.S. patent application Ser. No. ______, filed on Oct. ______, 2013 (Attorney Docket No. 52105-1060) and entitled “Integrated Tracking with Fiducial-based Modeling,” and U.S. patent application Ser. No. ______, filed on Oct. ______, 2013 (Attorney Docket No. 52105-1070) and entitled “Integrated Calibration Cradle,” all of which are hereby incorporated by reference in their entirety.

### BACKGROUND

There are various needs for understanding the shape and size of cavity surfaces, such as body cavities. For example, hearing aids, hearing protection, custom head phones, and wearable computing devices may require impressions of a patient's ear canal. To construct an impression of an ear canal, audiologists may inject a silicone material into a patient's ear canal, wait for the material to harden, and then provide the mold to manufacturers who use the resulting silicone impression to create a custom fitting in-ear device. As may be appreciated, the process is slow, expensive, and unpleasant for the patient as well as a medical professional performing the procedure.

Computer vision and photogrammetry generally relates to acquiring and analyzing images in order to produce data by electronically understanding an image using various algorithmic methods. For example, computer vision may be employed in event detection, object recognition, motion estimation, and various other tasks.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C are drawings of an scanning device according to various embodiments of the present disclosure.

FIG. 2 is a drawing of the scanning device of FIGS. 1A-1C performing a scan of a surface according to various embodiments of the present disclosure.

FIG. 3 is a pictorial diagram of an example user interface rendered by a display in data communication with the scanning device of FIGS. 1A-1C according to various embodiments of the present disclosure.

FIG. 4 is a drawing of a fiducial marker that may be used by the scanning device of FIGS. 1A-1C in pose estimation according to various embodiments of the present disclosure.

FIG. 5 is a drawing of the scanning device of FIGS. 1A-1C conducting a scan of an ear encompassed by the fiducial marker of FIG. 4 that may be used in pose estimation according to various embodiments of the present disclosure.

FIG. 6 is a drawing of a camera model that may be employed in an estimation of a pose of the scanning device of FIGS. 1A-1C according to various embodiments of the present disclosure.

FIG. 7 is a drawing of a partial bottom view of the scanning device of FIGS. 1A-1C according to various embodiments of the present disclosure.

FIG. 8 is a drawing illustrating the epipolar geometric relationships of at least two imaging devices in data communication with the scanning device of FIGS. 1A-1C according to various embodiments of the present disclosure.

FIGS. 9A-9C are examples calibration patterns according to various embodiments of the present disclosure.

FIGS. 10A and 10B are perspective views of an example of a calibration cradle used for calibration of the scanning device of FIGS. 1A-1C according to various embodiments of the present disclosure.

FIGS. 11A-11D are drawings illustrating examples of features of a probe of the scanning device of FIGS. 1A-1C according to various embodiments of the present disclosure.

FIG. 12 is a drawing illustrating calibration of the probe lens system of the scanning device of FIGS. 1A-1C according to various embodiments of the present disclosure.

FIG. 13 is a drawing illustrating calibration of the fan line of the scanning device of FIGS. 1A-1C according to various embodiments of the present disclosure.

FIGS. 14, 15A-15C and 16A-16C are flow charts illustrating examples of calibration of the scanning device of FIGS. 1A-1C according to various embodiments of the present disclosure.

FIG. 17 is a schematic block diagram that provides one example illustration of a computing system employed by the scanning device of FIGS. 1A-1C according to various embodiments of the present disclosure.

### DETAILED DESCRIPTION

The present disclosure relates to calibration of a mobile scanning device configured to scan and generate images and reconstructions of surfaces. Advancements in computer vision permit imaging devices, such as conventional cameras, to be employed as sensors useful in determining locations, shapes, and appearances of objects in a three-dimensional space. For example, a position and an orientation of an object in a three-dimensional space may be determined relative to a certain world coordinate system utilizing digital images captured via image capturing devices. As may be appreciated, the position and orientation of the object in the three-dimensional space may be beneficial in generating additional data about the object, or about other objects, in the same three-dimensional space. Calibration of the imaging system ensures accurate modeling of the imaged space.

For example, scanning devices may be used in various industries to scan objects to generate data pertaining to the objects being scanned. A scanning device may employ an imaging device, such as a camera, to determine information about the object being scanned, such as the size, shape, or structure of the object, the distance of the object from the scanning device, etc.

As a non-limiting example, a scanning device may include an otoscanner configured to visually inspect or scan a cavity such as, e.g., the ear canal of a human or animal. An otoscanner may comprise one or more cameras that may be beneficial in generating data about the cavity subjected to the scan, such as the size, shape, or structure of the ear canal. This data may be used in generating three-dimensional reconstructions of the ear canal that may be useful in customizing in-ear devices, for example but not limited to, hearing aids or wearable computing devices.

Determining the size, shape, or structure of an object subject to a scan may require information about a position of the object relative to the scanning device conducting the scan. For example, during a scan, a distance of an otoscanner from an ear canal may be beneficial in determining the shape of the ear canal. An estimated position of the scanning device relative to the object being scanned (i.e., the pose estimate) may be generated using various methods, as will be described in greater detail below.

According to one embodiment, determining an accurate pose estimate for a scanning device (e.g., an otoscanner) may comprise employing one or more fiducial markers to be imaged via one or more imaging devices in data communication with the scanning device. By being imaged via the imaging devices, the fiducial marker may act as a point of reference or as a measure in estimating a pose (or position) of the scanning device. A fiducial marker may comprise, for example, a circle-of-dots fiducial marker comprising a plurality of machine-identifiable regions (also known as “blobs”). In other embodiments, the tracking targets may be naturally occurring features surrounding and/or within the cavity to be scanned. Fiducial markers may also be used for calibration of the scanning device.

As a scanning device is performing a scan of an object, the one or more imaging devices may generate one or more digital images. The digital images may be analyzed for the presence of at least a portion of the one or more circle-of-dots fiducial markers. Subsequently, an identified portion of the one or more circle-of-dots fiducial markers may be analyzed and used in determining a relatively accurate pose estimate for the scanning device. The pose estimate may be used in generating three-dimensional reconstructions of a cavity such as, e.g., an ear canal. In the following discussion, a general description of the system and its components is provided, followed by a discussion of the operation of the same.

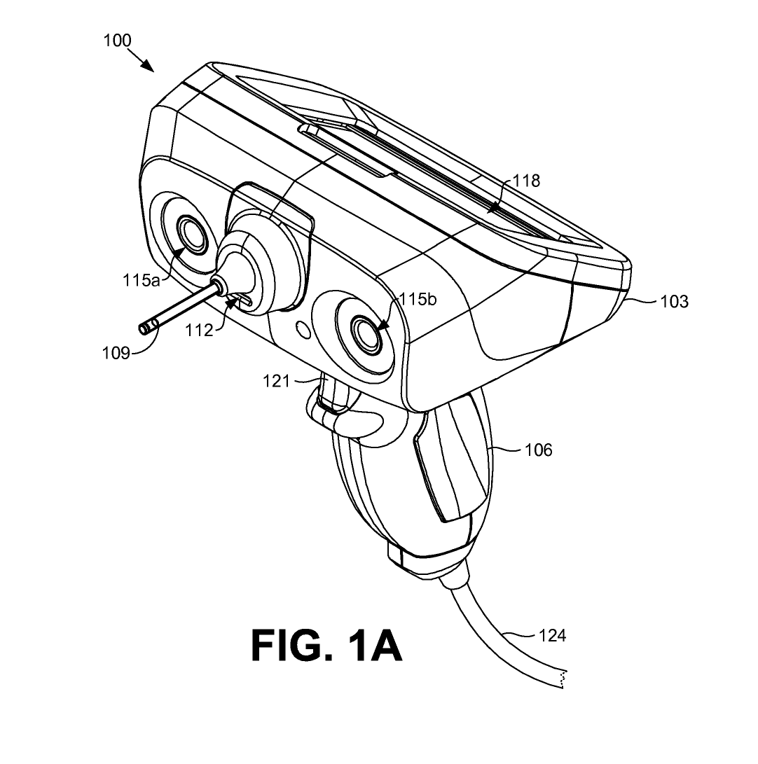

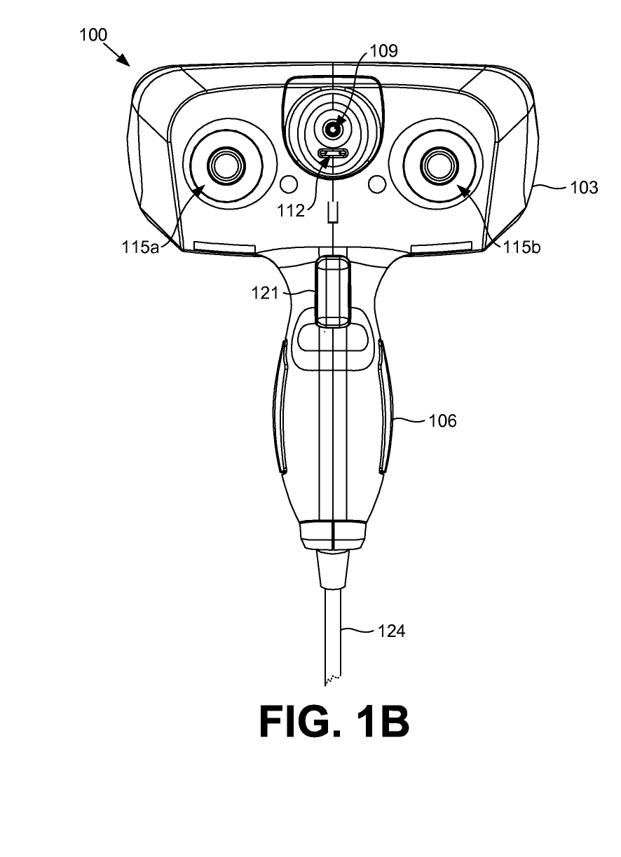

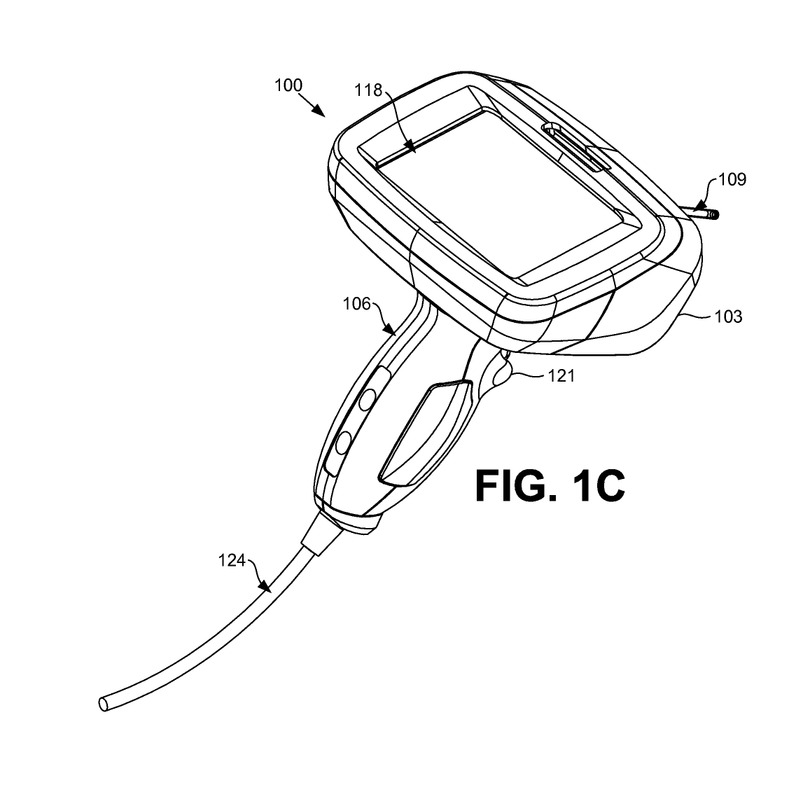

With reference to FIG. 1A, shown is a drawing of an example of a scanning device 100 according to various embodiments of the present disclosure. The scanning device 100, as illustrated in FIG. 1A, may comprise, for example, a body 103 and a hand grip 106. Mounted upon the body 103 of the scanning device 100 are a probe 109, a fan light element 112, and a plurality of tracking sensors 115 comprising, for example, a first imaging device 115a and a second imaging device 115b. The probe 109, with an imaging sensor, provides a third imaging device that allows for the capture of images of a scanned surface. According to various embodiments, the scanning device 100 may further comprise a display screen 118 configured to render images captured via the probe 109, the first imaging device 115a, the second imaging device 115b, and/or other imaging devices. The display screen 118 may also provide indications related to the calibration of the scanning device 100.

The hand grip 106 may be configured such that the length is long enough to accommodate large hands and the diameter is small enough to provide enough comfort for smaller hands. A trigger 121, located within the hand grip 106, may perform various functions such as initiating a scan of a surface, controlling a user interface rendered in the display, initiating a calibration process and/or otherwise modifying the function of the scanning device 100.

The scanning device 100 may further comprise a cord 124 that may be employed to communicate data signals to external computing devices and/or to power the scanning device 100. As may be appreciated, the cord 124 may be detachably attached to facilitate the mobility of the scanning device 100 when held in a hand via the hand grip 106. According to various embodiments of the present disclosure, the scanning device 100 may not comprise a cord 124, thus acting as a wireless and mobile device capable of wireless communication.

The probe 109 mounted onto the scanning device 100 may be configured to guide light received at a proximal end of the probe 109 to a distal end of the probe 109 and may be employed in the scanning of a surface cavity such as, e.g., an ear canal, by placing the probe 109 near or within the surface cavity. During a scan, the probe 109 may be configured to project a 360-degree ring onto the cavity surface and capture reflections from the projected ring to reconstruct the image, size, and shape of the cavity surface. In addition, the scanning device 100 may be configured to capture video images of the cavity surface by projecting video illuminating light onto the cavity surface and capturing video images of the cavity surface. The scanning device 100 may also be configured to verify calibration of the probe 109.

The fan light element 112 mounted onto the scanning device 100 may be configured to emit light in a fan line for scanning an outer surface. The fan light element 112 comprises a fan light source projecting light onto a single element lens to collimate the light and generate a fan line for scanning the outer surface. By using triangulation of the reflections captured when projected onto a surface, the imaging system within the scanning device 100 may reconstruct a three-dimensional (3D) image of the scanned surface. Calibration of the fan line emitted by the fan light element 112 may also be verified.

FIG. 1A illustrates an example of a first imaging device 115a and a second imaging device 115b mounted on or within the body 103 of the scanning device 100, for example, in an orientation that is opposite from the display screen 118. The display screen 118, as will be discussed in further detail below, may be configured to render a digital image of a surface cavity captured by the scanning device 100 as the probe 109 is moved within the cavity. The display screen 118 may also display, either separately or simultaneously, real-time constructions of three-dimensional images corresponding to the scanned cavity, as will be discussed in greater detail below.

Referring next to FIG. 1B, shown is another drawing of the scanning device 100 according to various embodiments. In this example, the scanning device 100 comprises a body 103, a probe 109, a hand grip 106, a fan light element 112, a trigger 121, and a cord 124 (optional), all implemented in a fashion similar to that of the scanning device described above with reference to FIG. 1A. In the examples of FIGS. 1A and 1B, the scanning device 100 is implemented with the first imaging device 115a and the second imaging device 115b mounted within the body 103 without hindering or impeding a view of the first imaging device 115a and/or a second imaging device 115b. According to various embodiments of the present disclosure, the placement of the imaging devices 115 may vary as needed to facilitate accurate pose estimation, as will be discussed in greater detail below.

Turning now to FIG. 1C, shown is another drawing of the scanning device 100 according to various embodiments. In the non-limiting example of FIG. 1C, the scanning device 100 comprises a body 103, a probe 109, a hand grip 106, a trigger 121, and a cord 124 (optional), all implemented in a fashion similar to that of the scanning device described above with reference to FIGS. 1A-1B.

In the examples of FIGS. 1A, 1B, and 1C, the scanning device 100 is implemented with the probe 109 mounted on the body 103 between the hand grip 106 and the display screen 118. The display screen 118 is mounted on the opposite side of the body 103 from the probe 109 and distally from the hand grip 106. To this end, when an operator takes the hand grip 106 in the operator's hand and positions the probe 109 to scan a surface, both the probe 109 and the display screen 118 are easily visible at all times to the operator.

Further, the display screen 118 is coupled for data communication to the imaging devices 115 (not shown). The display screen 118 may be configured to display and/or render images of the scanned surface. The displayed images may include digital images or video of the cavity captured by the probe 109 and the fan light element 112 (not shown) as the probe 109 is moved within the cavity. The displayed images may also include real-time constructions of three-dimensional images corresponding to the scanned cavity. The display screen 118 may be configured, either separately or simultaneously, to display the video images and the three-dimensional images, as will be discussed in greater detail below.

According to various embodiments of the present disclosure, the imaging devices 115 of FIGS. 1A, 1B, and 1C, may comprise a variety of cameras to capture one or more digital images of a surface cavity subject to a scan. A camera is described herein as a ray-based sensing device and may comprise, for example, a charge-coupled device (CCD) camera, a complementary metal-oxide semiconductor (CMOS) camera, or any other appropriate camera. Similarly, the camera employed as an imaging device 115 may comprise one of a variety of lenses such as: apochromat (APO), process with pincushion distortion, process with barrel distortion, fisheye, stereoscopic, soft-focus, infrared, ultraviolet, swivel, shift, wide angle, any combination thereof, and/or any other appropriate type of lens.

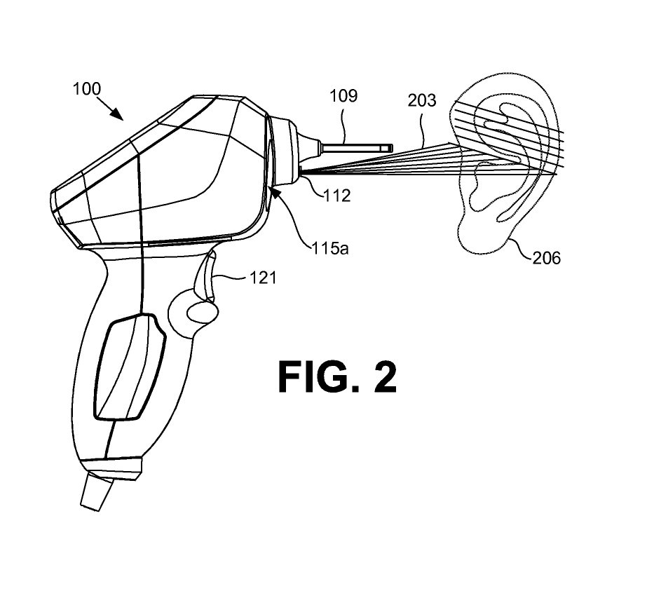

Moving on to FIG. 2, shown is an example of the scanning device 100 emitting a fan line 203 for scanning a surface. In this example, the scanning device 100 is scanning the surface of an ear 206. However, it should be noted that the scanning device 100 may be configured to scan other types of surfaces and is not limited to human or animal applications. The fan light element 112 may be designed to emit a fan line 203 formed by projecting divergent light generated by the fan light source onto the fan lens. As the fan line 203 is projected onto a surface, the lens system may capture reflections of the fan line 203. An image sensor may use triangulation to construct an image of the scanned surface based at least in part on the reflections captured by the lens system. Accordingly, the constructed image may be displayed on the display screen 118 (FIGS. 1A and 1C) and/or other displays in data communication with the scanning device 100.

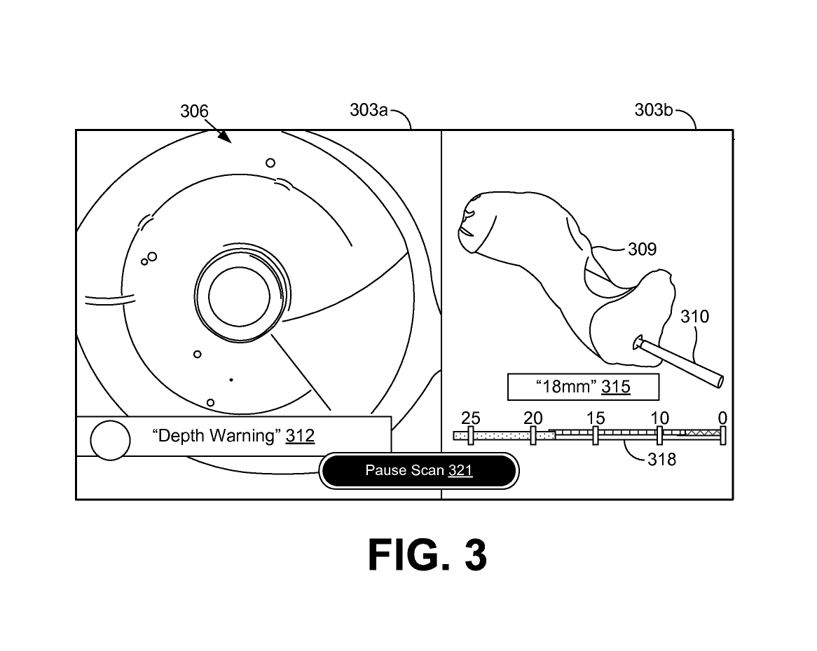

Referring next to FIG. 3, shown is an example user interface that may be rendered, for example, on a display screen 118 within the scanning device 100 and/or on another display that is communicatively coupled with the scanning device 100. In the non-limiting example of FIG. 3, a user interface may comprise a first portion 303a and a second portion 303b rendered separately or simultaneously in a display. For example, in the first portion 303a, a real-time video stream may be rendered, providing an operator of the scanning device 100 with a view of a surface cavity being scanned. The real-time video stream may be generated via the probe 109 or via one of the imaging devices 115.

In the second portion 303b, a real-time three-dimensional reconstruction of the object being scanned may be rendered, providing the operator of the scanning device 100 with an estimate regarding what portion of the surface cavity has been scanned. For example, the three-dimensional reconstruction may be non-existent as a scan of a surface cavity is initiated by the operator. As the operator progresses in conducting a scan of the surface cavity, a three-dimensional reconstruction of the surface cavity may be generated portion-by-portion, progressing into a complete reconstruction of the surface cavity at the completion of the scan. In the non-limiting example of FIG. 3, the first portion 303a may comprise, for example, an inner view of an ear canal 306 generated by the probe 109 and the second portion 303b may comprise, for example, a three-dimensional reconstruction of an ear canal 309, or vice versa.

A three-dimensional reconstruction of an ear canal 309 may be generated via processing circuitry including, e.g., one or more processors internal to the scanning device 100, external to the scanning device 100, or a combination thereof. Generating the three-dimensional reconstruction of the object subject to the scan may require information related to the pose of the scanning device 100. The three-dimensional reconstruction of the ear canal 309 may further comprise, for example, a probe model 310 emulating a position of the probe 109 relative to the surface cavity being scanned by the scanning device. Determining the information that may be used in the three-dimensional reconstruction of the object subject to the scan and the probe model 310 will be discussed in greater detail below.

A notification area 312 may provide the operator of the scanning device with notifications, whether assisting the operator with conducting a scan or warning the operator of potential harm to the object being scanned. Measurements 315 may be rendered in the display to assist the operator in conducting scans of surface cavities at certain distances and/or depths. A bar 318 may provide the operator with an indication of which depths have been thoroughly scanned as opposed to which depths or distances remain to be scanned. One or more buttons 321 may be rendered at various locations of the user interface permitting the operator to initiate a scan of an object and/or manipulate the user interface presented on the display screen 118 or other display in data communication with the scanning device 100. According to one embodiment, the display screen 118 comprises a touch-screen display and the operator may engage button 321 to pause and/or resume an ongoing scan.

Although portion 303a and portion 303b are shown as being simultaneously displayed in a side-by-side arrangement, other embodiments may be employed without deviating from the scope of the user interface. For example, portion 303a may be rendered in the display screen 118 on the scanning device 100 and portion 303b may be located on a display external to the scanning device 100, and vice versa.

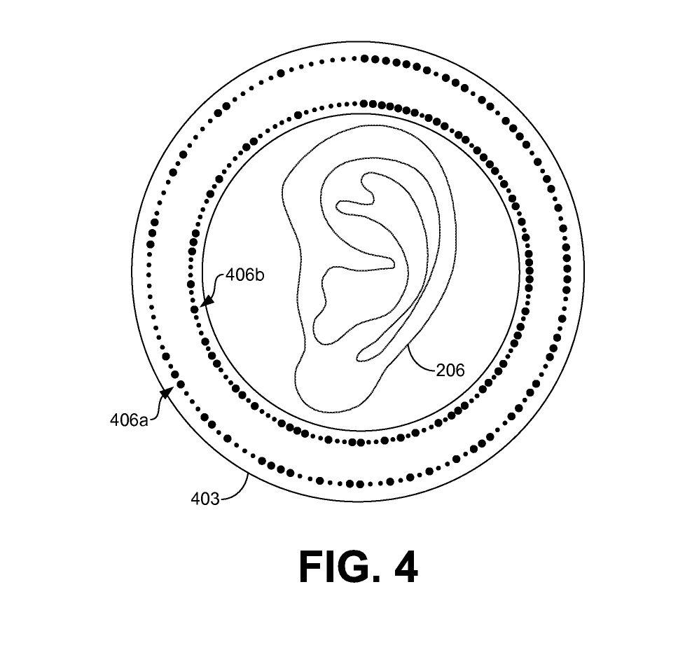

Turning now to FIG. 4, shown is a drawing of an example of a fiducial marker 403 that may be employed in pose estimation during a scan of an ear 206 or other surface. As shown in the non-limiting example of FIG. 4, the fiducial marker 403 may comprise a first circle-of-dots 406a and a second circle-of-dots 406b that generate a ring circumnavigating the fiducial marker 403. Although shown as a circular arrangement, the fiducial marker 403 is not so limited, and may comprise alternatively an oval, square, elliptical, rectangular, or appropriate geometric arrangement.

According to various embodiments of the present disclosure, a circle-of-dots 406 may comprise, for example, a combination of uniformly or variably distributed large dots and a small dots that, when detected, represent a binary number. For example, in the event seven dots in a circle-of-dots 406 are detected in a digital image, the sequence of seven dots may be analyzed to identify (a) the size of the dots and (b) a binary number corresponding to the arrangement of the dots. Detection of a plurality of dots in a digital image may be employed using known region- or blob-detection techniques, as may be appreciated.

As a non-limiting example, a sequence of seven dots comprising small-small-large-small-large-large-large may represent an identifier represented as a binary number of 0-0-1-0-1-1-1 (or, alternatively, 1-1-0-1-0-0-0). The detection of this arrangement of seven dots, represented by the corresponding binary number, may be indicative of a pose of the scanning device 100 relative to the fiducial marker 403. For example, a lookup table may be used to map the binary number to a pose estimate, providing at least an initial estimated pose that may be refined and/or supplemented using information inferred via one or more camera models, as will be discussed in greater detail below. Although the example described above employs a binary operation using a combination of small dots and large dots to form a circle-of-dots 406, variable size dots (having, for example, β sizes) may be employed using variable base numeral systems (for example, a base-fl numeral system).

The arrangement of dots in the second circle-of-dots 406b may be the same as the first circle-of-dots 406a, or may vary. If the second circle-of-dots 406b comprises the same arrangement of dots as the first circle-of-dots 406a, then the second circle-of-dots 406b may be used independently or collectively (with the first circle-of-dots 406a) to determine an identifier indicative of the pose of the scanning device 100. Similarly, the second circle-of-dots 406b may be used to determine an error of the pose estimate determined via the first circle-of-dots 406a, or vice versa.

Accordingly, a fiducial marker 403 may be placed relative to the object being scanned to facilitate in accurate pose estimation of the scanning device 100. In the non-limiting example of FIG. 4, the fiducial marker 403 may circumscribe or otherwise surrounds an ear 206 subject to a scan via the scanning device 100. In one embodiment, the fiducial marker 403 may be detachably attached around the ear of a patient using a headband or similar means. In other embodiments, a fiducial marker 403 may be detachably attached or affixed to a surface around the cavity to be scanned.

In other embodiments, a fiducial marker may not be needed, as the tracking targets may be naturally occurring features surrounding and/or within the cavity to be scanned detectable by employing various computer vision techniques. For example, assuming that a person's ear is being scanned by the scanning device 100, the tracking targets may include, hair, folds of the ear, skin tone changes, freckles, moles, and/or any other naturally occurring feature on the person's head relative to the ear.

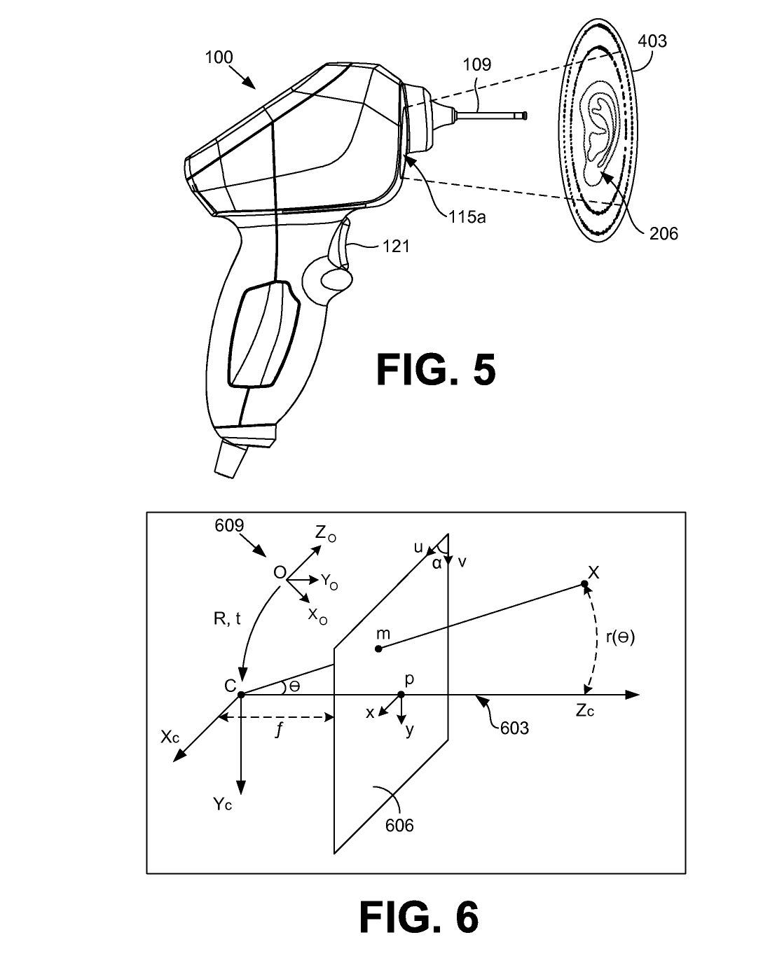

Moving on to FIG. 5, shown is an example of the scanning device 100 conducting a scan of an object. In the non-limiting example of FIG. 5, the scanning device 100 is scanning the surface of an ear 206. However, it should be noted that the scanning device 100 may be configured to scan other types of surfaces and is not limited to human or animal applications. During a scan, a first imaging device 115a and a second imaging device 115b (FIGS. 1A and 1B) may capture digital images of the object subject to the scan. As described above with respect to FIG. 4, a fiducial marker 403 may circumscribe or otherwise surround the object subject to the scan. Thus, while an object is being scanned by the probe 109, the imaging devices 115 may capture images of the fiducial marker 403 that may be used in the determination of a pose of the scanning device 100, as will be discussed in greater detail below.

Referring next to FIG. 6, shown is a camera model that may be employed in the determination of world points and image points using one or more digital images captured via the imaging devices 115. Using the camera model of FIG. 6, a mapping between rays and image points may be determined permitting the imaging devices 115 to behave as a position sensor. In order to generate adequate three-dimensional reconstructions of a surface cavity subject to a scan, a pose of a scanning device 100 relative to six degrees of freedom (6DoF) is beneficial.

Initially, a scanning device 100 may be calibrated using the imaging devices 115 to capture calibration images of a calibration object whose geometric properties are known. By employing the camera model of FIG. 6 to the observations identified in the calibration images, internal and external parameters of the imaging devices 115 may be determined. For example, external parameters describe the orientation and position of an imaging device 115 relative to a coordinate frame of an object. Internal parameters describe a projection from a coordinate frame of an imaging device 115 onto image coordinates. Having a fixed position of the imaging devices 115 on the scanning device 100, as depicted in FIGS. 1A-1C, permits the determination of the external parameters of the scanning device 100 as well. The external parameters of the scanning device 100 may be used to generate three-dimensional reconstructions of a surface cavity subject to a scan.

In the camera model of FIG. 6, projection rays meet at a camera center defined as C, wherein a coordinate system of the camera may be defined as X_{c}, Y_{c}, Z_{c}, where Z_{c} is defined as the principal axis 603. A focal length f defines a distance from the camera center to an image plane 606 of an image captured via an imaging device 115. Using a calibrated camera model, perspective projections may be represented via:

$$( \begin{matrix}x \\ y \\ 1\end{matrix} ) ≃ [ \begin{matrix}f & 0 & 0 & 0 \\ 0 & f & 0 & 0 \\ 0 & 0 & 1 & 0\end{matrix} ] ( \begin{matrix}{X}_{c} \\ {Y}_{c} \\ {Z}_{c} \\ 1\end{matrix} ) \qquad ( eq . 1 )$$

A world coordinate system 609 with principal point O may be defined separately from the camera coordinate system as X_{O}, Y_{O}, Z_{O}. According to various embodiments, the world coordinate system 609 may be defined at a base location of the probe 109 of the scanning device 100, however, it is understood that various locations of the scanning device 100 may be used as the base of the world coordinate system 609. Motion between the camera coordinate system and the world coordinate system 609 is defined by a rotation R, a translation t, a tilt φ. A principal point p is defined as the origin of a normalized image coordinate system (x, y) and a pixel image coordinate system is defined as (u,v), wherein α is

$$( \frac{π}{2} )$$

in a conventional orthogonal pixel coordinate axes. The mapping of a three-dimensional point X to the digital image m is represented via:

$$\begin{matrix}m ≃ [ \begin{matrix}{m}_{u} & - {m}_{u} cot ( α ) & {u}_{0} \\ 0 & \frac{{m}_{v}}{sin ( α )} & {v}_{0} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R & t \\ 0 & 1\end{matrix} ] X \\ = [ \begin{matrix}{m}_{u} f & - {m}_{u} f cot ( α ) & {u}_{0} \\ 0 & \frac{{m}_{v}}{sin ( α )} f & {v}_{0} \\ 0 & 0 & 1\end{matrix} ] [ \begin{matrix}R & t\end{matrix} ] X\end{matrix} \qquad ( eq . 2 )$$

Further, the camera model of FIG. 6 may account for distortion deviating from a rectilinear projection. Radial distortion generated by various lenses of an imaging device 115 may be incorporated into the camera model of FIG. 6 by considering projections in a generic model represented by:

r(θ)=1+k₂θ³+k₃θ⁵+k₄θ⁷+ . . . (eq. 3)

As eq. 3 shows a polynomial with four terms up to the seventh power of θ, the polynomial of eq. 3 provides enough degrees of freedom (e.g., six degrees of freedom) for a relatively accurate representation of various projection curves that may be produced by a lens of an imaging device 115. Other polynomial equations with lower or higher orders or other combinations of orders may be used.

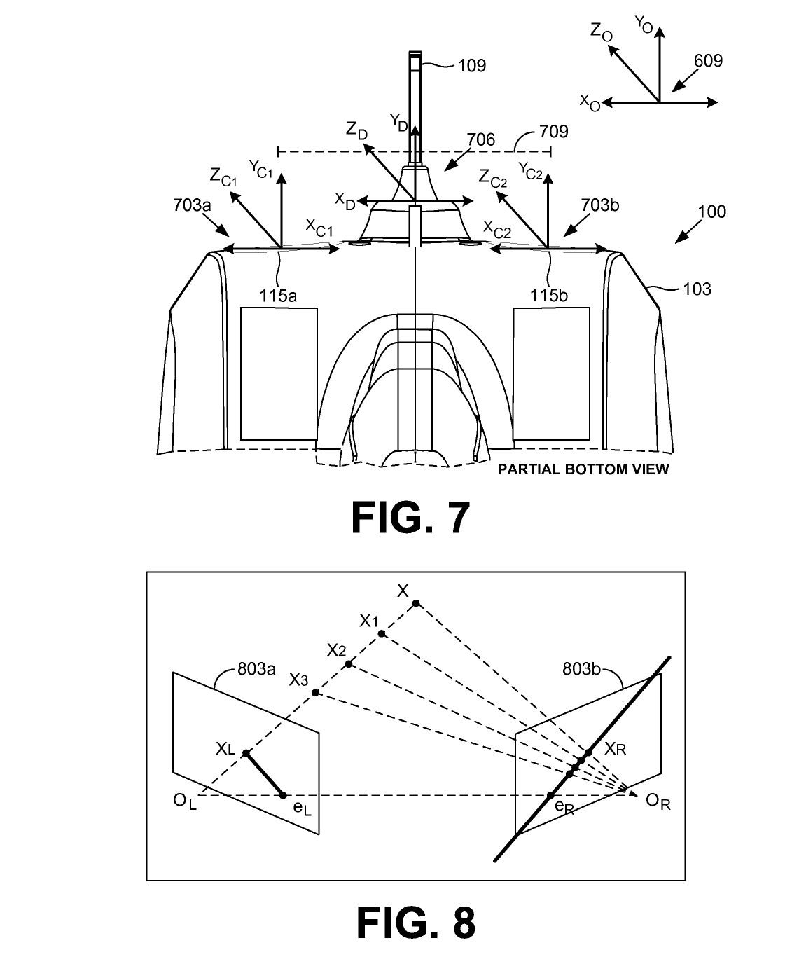

Turning now to FIG. 7, shown is another drawing of a portion of the scanning device 100 according to various embodiments. In this example, the scanning device 100 comprises a first imaging device 115a and a second imaging device 115b, all implemented in a fashion similar to that of the scanning device described above with reference to FIGS. 1A-1C. The first imaging device 115a and the second imaging device 115b may be mounted within the body 103 without hindering or impeding a view of the first imaging device 115a and/or the second imaging device 115b.

The placement of two imaging devices 115 permits computations of positions using epipolar geometry. For example, when the first imaging device 115a and the second imaging device 115b view a three-dimensional scene from their respective positions (different from the other imaging device 115), there are geometric relations between the three-dimensional points and their projections on two-dimensional images that lead to constraints between the image points. These geometric relations may be modeled via the camera model of FIG. 6 and may incorporate the world coordinate system 609 and one or more camera coordinate systems (e.g., camera coordinate system 703a and camera coordinate system 703b).

By determining the internal parameters and external parameters for each imaging device 115 via the camera model of FIG. 6, the camera coordinate system 703 for each of the imaging devices 115 may be determined relative to the world coordinate system 609. The geometric relations between the imaging devices 115 and the scanning device 100 may be modeled using tensor transformation (e.g., covariant transformation) that may be employed to relate one coordinate system to another. Accordingly, a device coordinate system 706 may be determined relative to the world coordinate system 609 using at least the camera coordinate systems 603. As may be appreciated, the device coordinate system 706 relative to the world coordinate system 609 comprises the pose estimate of the scanning device 100.

In addition, the placement of the two imaging device 115 in the scanning device 100 may be beneficial in implementing computer stereo vision. For example, both imaging devices 115 can capture digital images of the same scene; however, they are separated by a distance 709. A processor in data communication with the imaging devices 115 may compare the images by shifting the two images together over the top of each other to find the portions that match to generate a disparity used to calculate a distance between the scanning device 100 and the object of the picture. However, implementing the camera model of FIG. 6 is not as limited as an overlap between two digital images taken by a respective imaging device 115 and may not be warranted when determining independent camera models for each imaging device 115.

Moving on to FIG. 8, shown is the relationship between a first image 803a captured, for example, by the first imaging device 115a and a second image 803b, for example, captured by the second imaging device 115b. As may be appreciated, each imaging device 115 is configured to capture a two-dimensional image of a three-dimensional world. The conversion of the three-dimensional world to a two-dimensional representation is known as perspective projection, which may be modeled as described above with respect to FIG. 6. The point X_{L} and the point X_{R} are shown as projections of point X onto the image planes. Epipole e_{L} and epipole e_{R} have centers of projection O_{L} and O_{R} on a single three-dimensional line. Using projective reconstruction, the constraints shown in FIG. 8 may be computed.

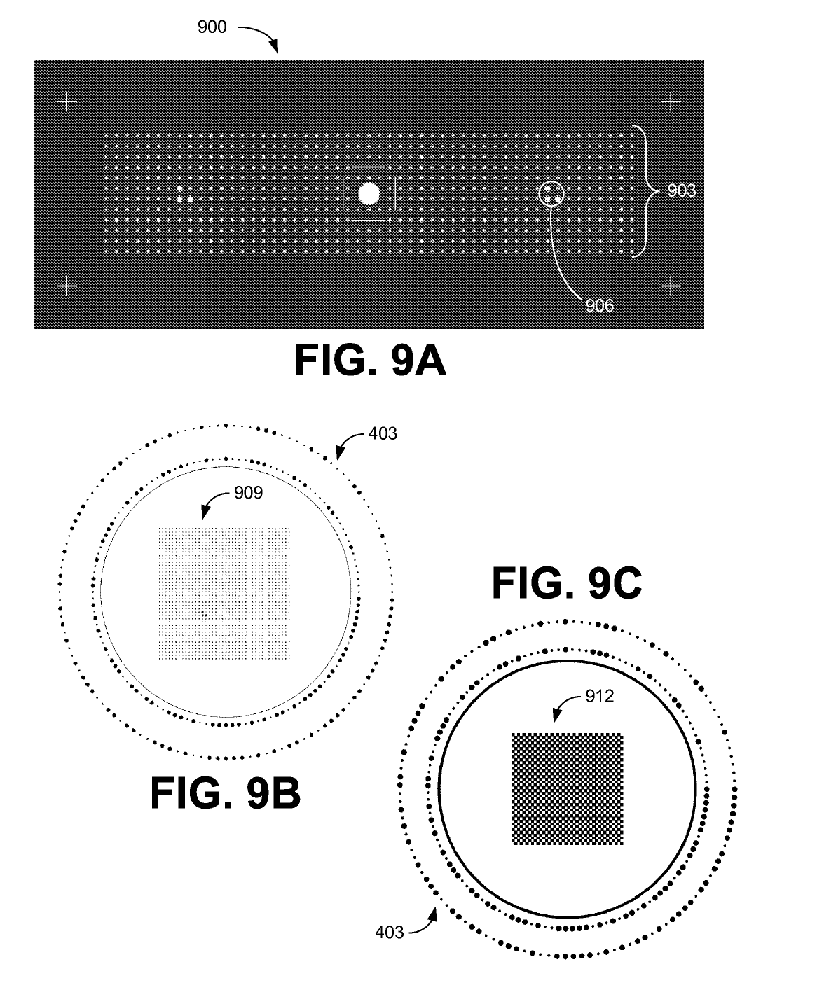

Calibration of the tracking sensors 115 can improve accuracy of the generated model of the imaged space (e.g., cavity surface). A calibration pattern is used to calibrate the tracking parameters (e.g., focal length, optical center, lens distortion, and/or pose parameters) for the tracking sensors 115. Referring to FIG. 9A, shown is an example of a calibration pattern 900. The calibration pattern 900 includes a plurality of dots 903 distributed across the pattern in a known distribution. Calibration of the tracking parameters can be improved by filling the image with as many dots as possible. The calibration pattern 900 may include a central reference mark 906 with, e.g., special markings or dots in the center of tracking sensor viewing area to assist in identification of the origin and orientation of the x-axis and y-axis of the pattern. In the example of FIG. 9A, a central reference mark 906 in the right half of the calibration pattern 900 includes three enlarged dots that allow for identification and orientation for one of the tracking sensors 115. Similar central reference mark is provided in the left half of the calibration pattern 900 for the other tracking sensor 115. In some implementations, a central reference mark is provided for each tracking sensor 115. Other calibration patterns may also be used such as, e.g., concentric rings of dots surrounding a center reference mark or other appropriate geometric pattern. In other embodiments, the calibration pattern may use a grid pattern instead of a dot pattern. FIGS. 9B and 9C illustrate other examples of calibration patterns. In the example of FIG. 9B, a dot pattern 909 is surrounded by the fiducial marker 403 of FIG. 4. The fiducial marker 403 may be used to assist in identification of the origin and orientation of the x-axis and y-axis of the pattern. A reference mark may also be included in the calibration pattern as illustrated. In the example of FIG. 9C, a grid pattern 912 is surrounded by the fiducial marker 403.

Calibration of the tracking parameters is similar to tracking of the fiducial markers 403 of FIG. 4. The tracking sensors 115 are used to identify a set or series of dots, which are used to calibrate the tracking parameters. Once the origin is identified and the orientation of the x-axis and y-axis determined, the location of the other dots in the calibration pattern 900, as defined by image coordinates, can be determined. The orientation may be determined using reference markings 906 in the calibration pattern and/or the fiducial marker 403. The dot locations may then be considered to be a list of points that define the measured centroids of the dots. An estimate of the dot locations can then be determined using an estimate of the tracking parameters. For example, theoretical values (or approximations) of the tracking parameters that are based upon the known geometry of the lenses and their placement in the scanning device 100 may be used as initial estimates of the tracking parameters. Since the distortion of the lenses may not be known, it may initially be assumed that no distortion is present by setting the lens distortion parameters to zero.

First, some of the dots 903 in the calibration pattern 900 are used to determine an estimated pose of the scanning device 100 (and thus the tracking sensors 115) relative to the dots 903 of the calibration pattern 900. With the estimated pose and the other estimated tracking parameter values, a set of dot locations are projected out to the plane of the calibration pattern 900. The difference between the projected location and the actual location of the dots of the calibration pattern 900 are used as errors to adjust the tracking parameters. In this way, a gradient dissent algorithm may be used to calibrate the parameters to minimize the errors between the projected and actual locations. A gradient dissent algorithm such as, e.g., Powell's conjugate direction method (which may utilize Brent's method for linear search and optimization) can be used to iteratively determine the tracking parameter values. In some implementations, calibration of the tracking parameter values continues until the errors are minimized and/or nor further improvement is exhibited. For example, a total error may be examined to determine whether the errors have been minimized. In other implementations, the calibration continues until the error values fall below one or more predefined values.

Multiple images or views of the calibration pattern 900 may be obtained for calibration of the tracking sensors 115. By including depth information available through the different images, the parameter calibration may be improved. For example, during an initial calibration of the scanning device 100, a set of images may be obtained at a series of predefined locations. This may be accomplished using a robotic control that repositions the scanning device 100 as the images are captured. The captured images may then be used for calibration of the tracking parameters at different viewing distances.

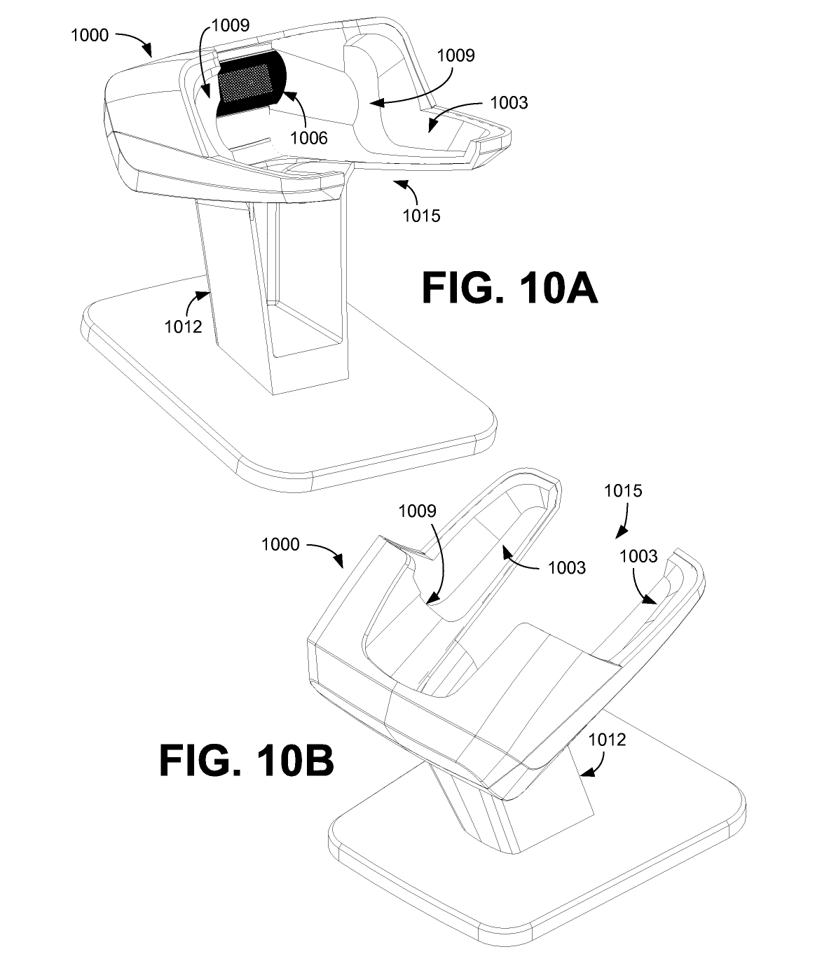

In many situations, it is beneficial to verify the calibration of the scanning device 100 in the field. This may be accomplished using a cradle that holds the scanning device in a fixed position. Referring to FIGS. 10A and 10B, shown are views of an example of a calibration cradle 1000. The calibration cradle 1000 includes two recesses 1003 in which the sides of the scanning device 100 rest. The recesses 1003 include shoulders 1009 that to hold the scanning device 100 at a fixed distance from an inner surface 1006 of the calibration cradle 1000. In some embodiments, the scanning device 100 may include recesses that match positioning pins that extend upward in the recesses 1003. In this way, the scanning device 100 may be positioned within the calibration cradle 1000 within a known tolerance. The inner surface 1006 includes a calibration pattern such as the example of FIG. 9A. In some implementations, the calibration pattern may include a portion of the fiducial maker around the dot or grid pattern to assist in orientation. When positioned within the recesses 1003, the tracking sensors 115 and probe 109 of the scanning device 100 face the calibration pattern on the inner surface 1006 of the calibration cradle 1000.

A support stand 1012 positions the recesses 1003 at a height that allows the hand grip 106 of the scanning device 100 (FIGS. 1A-1C) to extend downward through a gap 1015 between the recesses 1003 without interfering with the alignment of the tracking sensors 115 and probe 109 with the calibration pattern. The upper portion of the calibration cradle 1000 can be angled as illustrated in FIGS. 10A and 10B to allow the weight of the scanning device 100 to hold it firmly against the shoulders 1009 of the recesses 1003.

A calibration check of the scanning device 100 may be carried out with the scanning device 100 positioned in the calibration cradle 1000. In some implementations, verification of the calibration of the scanning device 100 may be initiated with the scanning device 100 in the calibration cradle. For example, the trigger 121 may be pressed to start the calibration verification. In other embodiments, a button on the display screen 118 of the scanning device 100 or on an external computing device that is communicatively coupled with the scanning device 100. When initiated, one or more images of the calibration pattern may be obtained using the tracking sensors 115 of the scanning device 100 (FIGS. 1A-1C). Using some of the dots 903 in the calibration pattern 900 (FIG. 9A) and/or a portion of the fiducial marker 403 (FIGS. 9B and 9C), the pose of the scanning device 100 with respect to the calibration pattern may then be determined as discussed above. A set of dot locations may then be projected out to the plane of the calibration pattern. The difference between the projected location and the actual location of the dots of the calibration pattern provide an error indication.

If the error does not meet a defined error threshold, then an out-of-calibration indication can be provided to the user for corrective action. The error threshold may be dependent upon the distance to the calibration pattern. The indication may be, e.g., an error code or message that is displayed on the display screen 118 of the scanning device 100 or on a display screen of the external computing device. The calibration verification may be repeated multiple times while the scanning device 100 is located in the calibration cradle 1000 to verify the error before providing the out-of calibration indication. If the scanning device 100 is out-of-calibration, then it may be recalibrated by the manufacturer or a service provider. In some implementations, the scanning device 100 may be recalibrated using the calibration cradle 1000.

Recalibration of the scanning device 100 may be carried out in the field by capturing a series of images of the calibration pattern as the scanning device 100 is being positioned within the calibration cradle 1000. The field calibration of the scanning device 100 may be initiated using the trigger 121 and/or buttons on the display screen 118 or a display screen of an external computing device in communication with the scanning device 100. For example, a calibration mode may be selected through the display screen 118. The trigger may then be pressed to begin obtaining images of the calibration pattern as the scanning device 100 is placed in the recesses 1003 of the calibration cradle 1000. In some cases, a series of images may be captured at a predefined rate while the trigger 121 is held down. In other cases, the series of images may be captured until the trigger is pressed a second time.

The captured series of images may then be used to calibrate the tracking parameters as previously discussed. The field calibration may begin with the current parameters or may begin with a predefined set of calibration parameters. The use of the current tracking parameters can improve the speed of the field calibration. As discussed above, using some of the dots in the calibration pattern and/or a portion of a fiducial marker around the calibration pattern, the pose of the scanning device 100 with respect to the calibration pattern is determined for one of the captured images. A set of dot locations may then be projected out to the plane of the calibration pattern, with the difference between the projected location and the actual location of the dots of the calibration pattern providing an error indication that is used to adjust the tracking parameters. Gradient dissent can be used to iteratively minimize the errors to determine the parameter values. The calibration of the tracking parameters can be carried out using a plurality of the captured images at different distances from the calibration pattern. After recalibration of the tracking parameters, verification of the calibration may again be carried out to confirm the accuracy. A notification may then be provided to the user indicating whether the calibration is acceptable or not.

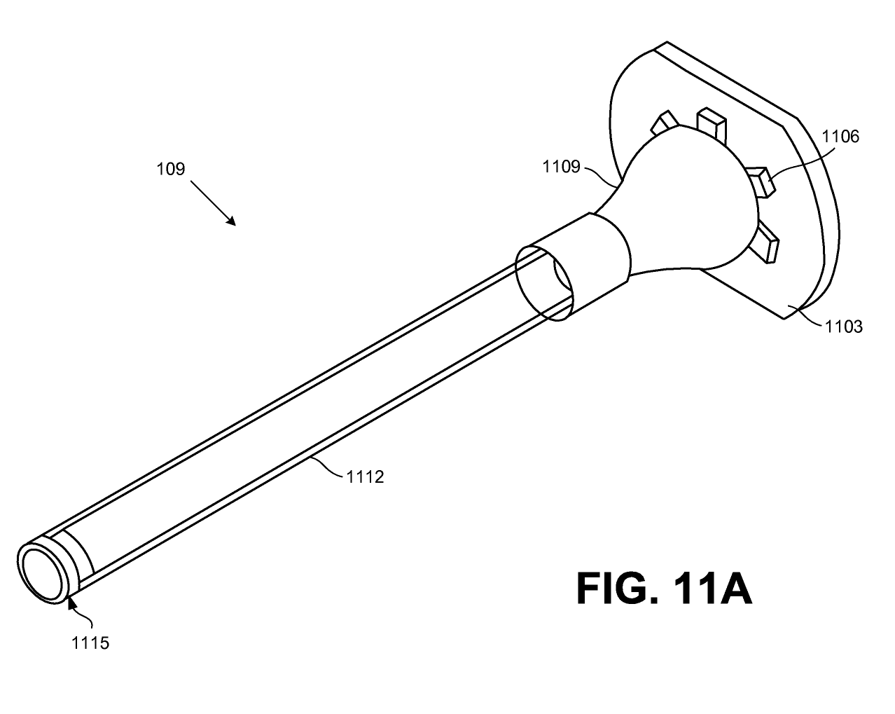

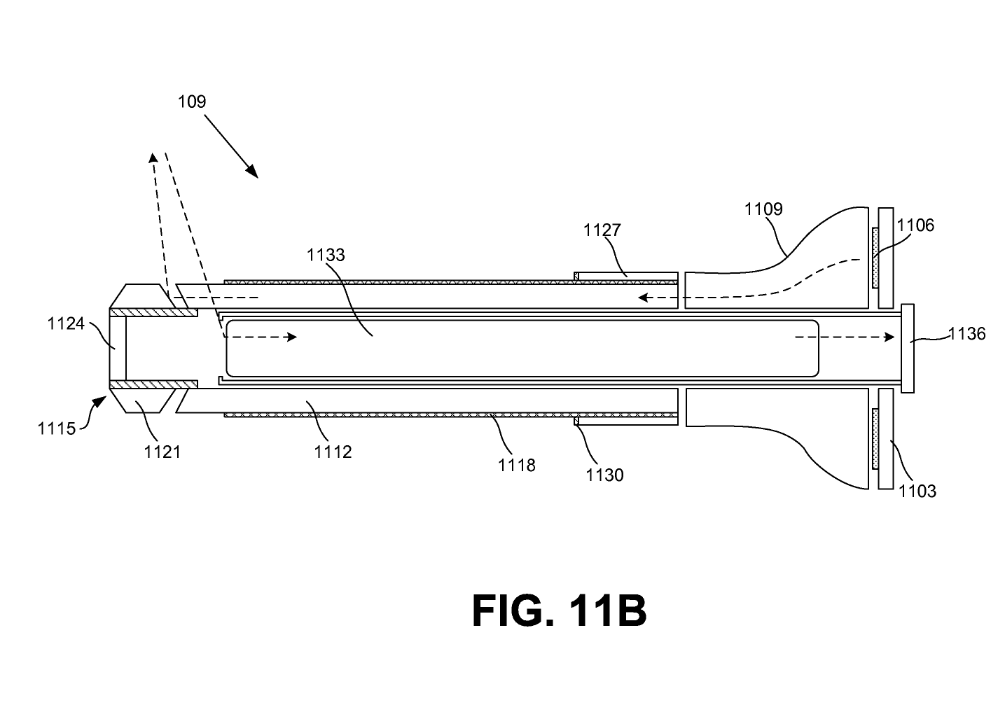

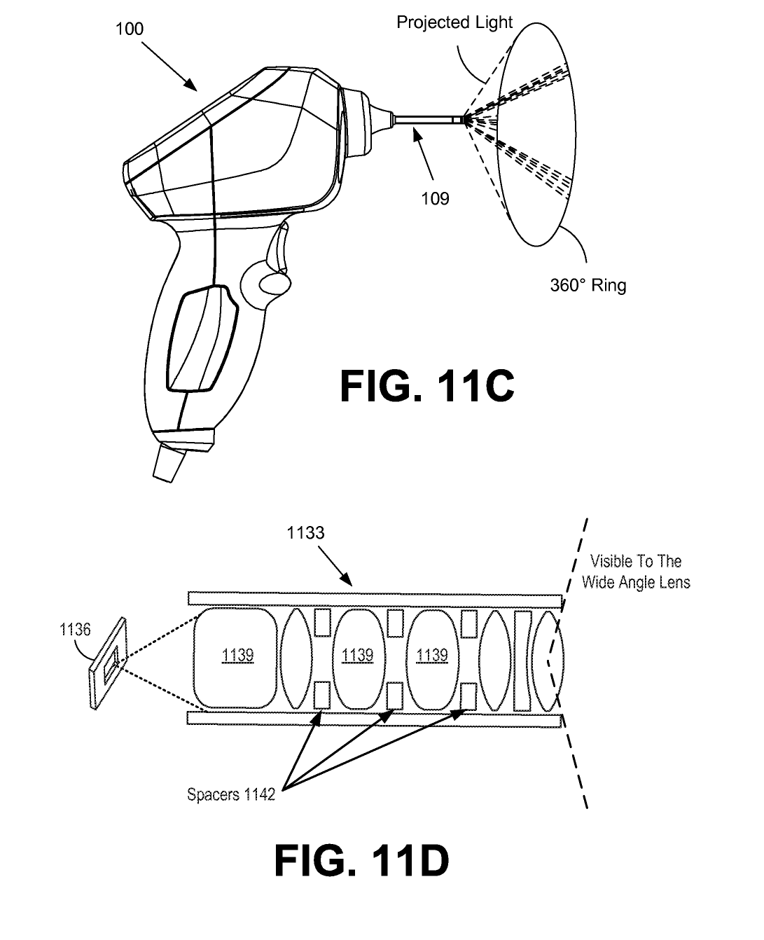

The probe 109, with an imaging sensor, provides a third imaging device that allows for the capture of images that can be used for 3D imaging of a scanned surface. Calibration of the probe 109 can also improve the accuracy of the generated model of the imaged space (e.g., cavity surface). Turning now to FIG. 11A, shown is an example of a probe 109 of the scanning device 100. The probe 109 may include a lighting element 1103, a light source 1106, an optical guide 1109, a tubular element 1112, a probe tip 1115, and/or other elements not illustrated. The lighting element 1103 may include one or more light sources 206 such as, e.g., a light emitting diode (LED), laser, other types of light sources, or combinations thereof. The probe 109 is designed to guide and approximately collimate light generated by the light source 1106 through the tubular element 1112 for projection onto a cavity surface. The light may be used for video illumination and/or scanning of the cavity surface. In some embodiments, one light source 1106 may generate light within a first wavelength range (e.g. about 450 nm and less) for scanning a surface cavity while another light source 1106 may generate light within a second wavelength range (e.g. about 500 nm and above) for video illumination of the surface cavity.

Referring to FIG. 11B, shown is a cross-sectional view of an example of the probe 109. The optical guide 109 is configured to guide light generated by the light source 1106 to the proximal end of the tubular element 1112. The tubular element 1112 may be designed to guide light received from the optical guide 1109 between the inner wall and the outer wall of the tubular element 1112 to the distal end of the tubular element 112. In some embodiments, the inner wall and/or outer wall of the tubular element 1112 may comprise a cladding to reduce the amount of light escaping form the tubular element 1112. Additionally, the cladding configuration approximately collimates the light being guided to the second end of the tubular element 1112. A frustration mask 1118 may also surround at least a portion of the tubular element 1112.

A probe tip 1115 is disposed at the distal end of the tubular element such that the light exiting the tubular element 1112 may be radially reflected at the probe tip 1115 for scanning or may be passed though the probe tip 1115 for video illumination. The probe tip 1115 may comprise a cone mirror 1121 and a distal window 1124. The cone mirror 1121 may be configured to radially reflect the light received from the tubular element 1112 forming a ring of light. For example, the cone mirror 1121 may form an unbroken 360 degree ring of light as shown in FIG. 11C, which can be projected onto a cavity surface. In some embodiments, the cone mirror 1121 may comprise a type of dichroic coating used to radially reflect light within a predefined wavelength range to produce the ring of light. Light within a second predefined wavelength range may be passed through the cone mirror 1121 and projected out of the distal end of the probe 109 through the probe tip 1115.

As illustrated in the example of FIG. 11B, the probe 109 may also include an illumination tube 1127, a filter element 1130, a lens system 1133, and/or an image sensor 1136. The illumination tube 1127 may project light from the probe 109 to be used for video illumination. The illumination tube 1127 may include a filter element 1130 designed to pass only light generated by the light source 1106 that generates the video illuminating light. For example, the filter element 1130 the may reflect the light in the first wavelength range back into the optical guide 1109 and allow light in the second wavelength range to pass through for illumination of the surface cavity.

Disposed within at least a portion of the tubular element 1112 is a lens system 1133 configured to capture reflections of the light that is radially reflected from the cone mirror 1121 or that passed through the cone mirror 1121 when the light is projected onto a cavity surface. The reflections of light may be captured by the lens system 1133 and guided through the inner channel of the probe 109 to an image sensor 1136 disposed adjacent to the lighting element 1103. The image sensor 1136 may be communicatively coupled to processing circuitry (not shown) for data communications and/or processing of the captured pixel information. The processing circuitry may be configured to construct a 3D image of the cavity surface, in dependence upon a sequence of images captured when the scanned cavity surface is illuminated by the scanning light and tracked positions of the probe 109 inferred from reflections of tracking illumination sensed by the tracking illumination sensors.

Referring next to FIG. 11D, shown in an example of the lens system 1133. The lens system 1133 comprises a wide-angle lens that is optically coupled to the image sensor 1136, with the lens and the sensor oriented so as to capture images of surfaces illuminated by light from the light sources 1106 of the probe 109. The wide angle lens that includes a number of lens elements 1139 and spacers 1142. The wide angle lens can have sufficient depth of field so that the entire portion of the surface of a cavity illuminated by light is in focus at the image sensor 1136. An image of a portion of the scanned cavity is said to be in focus if light from object points on the surface of the cavity is converged as much as reasonably possible at the image sensor 1136, and out of focus if light is not well converged.

The term “wide angle lens” as used herein refers to any lens configured for a relatively wide field of view that will work in tortuous openings such as an auditory canal. For example, for an auditory canal, a 63 degree angle results in a lens-focal surface offset about equal to the maximum diameter of the auditory canal that can be scanned with a centered ear probe. The focal surface of a 60 degree lens (a fairly standard sized wide angle lens) is equal to the diameter, resulting in a forward focal surface of about 6 mm, which typically is short enough to survive the second bend in an auditory canal which is at about a 6 mm diameter. For scanning auditory canals, therefore, wide angle lenses typically are 60 degrees or greater. Other functional increments include 90 degrees with its 2:1 ratio allowing a forward focal surface distance of about 3 mm, allowing an ear probe to be fairly short. Lenses that are greater than 90 degrees are possible as are lenses that include complex optical elements with sideways only views and no forward field of view. According to some embodiments, light is emitted from the probe 109 in the form of a ring or in the form of a fan, and the wide angle lens provides the same sufficient depth of field to portions of a scanned ear as illuminated by all such forms of light.

The wide angle lens can view relatively proximate lateral portions of a surface with high precision due to overlap of its focal surface with a pattern of projected light. The term “focal surface” refers to a thickness within a range of focus of the wide angle lens that is capable of achieving a certain base line resolution, such as being able to discern a 50 micrometer feature or smaller. For example, lateral positioning of a pattern of projected light within the focal surface can allow one pixel to be equivalent to about 50 micrometers. Such a focal surface itself would have a bell curve distribution of resolution that would allow variations in overlap or thickness of the focal surface and the width of the lateral portion of reflected light which has its own curved distribution across its thickness.

Video images of a scanned surface (e.g., an ear canal) may be captured through the distal window 1124 of the probe tip 1115 via the lens system 1133 and image sensor 1136 using the light projected out of the distal end of the probe 109. The image sensor 1136 can be configured to capture images at a predefined frame rate, which may then be displayed to the user of the scanning device 100. For the construction of 3D images of the scanned cavity or surface, a sequence of two dimensional (2D) images of the light reflected from the scanned surface are captured via the lens system 1133 and image sensor 1136. The light may be radially reflected at the probe tip 1115 as shown in FIG. 11C or may be projected from a fan light element 112 as shown in FIG. 2. The image sensor 1136 includes an array of light-sensitive pixels, and each captured image is a set of pixel identifiers such as pixel numbers and/or pixel coordinates with a brightness value for each pixel.

Ridge points for a 2D image make up a set of brightest pixels for the 2D image, a set that is assembled by scanning the pixel brightness values for each 2D image and selecting as ridge points only the brightest pixels. The ridge points can then be transformed to points in scanner space. The transformation can be carried out using a lookup table of defined associations between each pixel in the image sensor 1136 and corresponding points in scanner space. Each record of the lookup table represents an association between a pixel of the image sensor 1136 and a point in scanner space. For example, the pixels of the image sensor 1136 can be identified by their x,y coordinates in the image sensor itself, a defined numbering scheme, or in other ways as will occur to those of skill in the art. The association between each identified pixel and the corresponding point in scanner space can be identified during calibration of the scanning device 100. Separate lookup tables may be determined for light that is radially reflected at the probe tip 1115 as shown in FIG. 11C or projected from a fan light element 112 as shown in FIG. 2. Points in scanner space may then be transformed into points in the cavity (or ear) space for generation of a 3D model of the imaged space (e.g., cavity surface). Additional details are provided in U.S. patent application Ser. No. 13/417,649, filed on Mar. 12, 2012 and entitled “Otoscanning with 3D Modeling,” which is hereby incorporated by reference in its entirety.

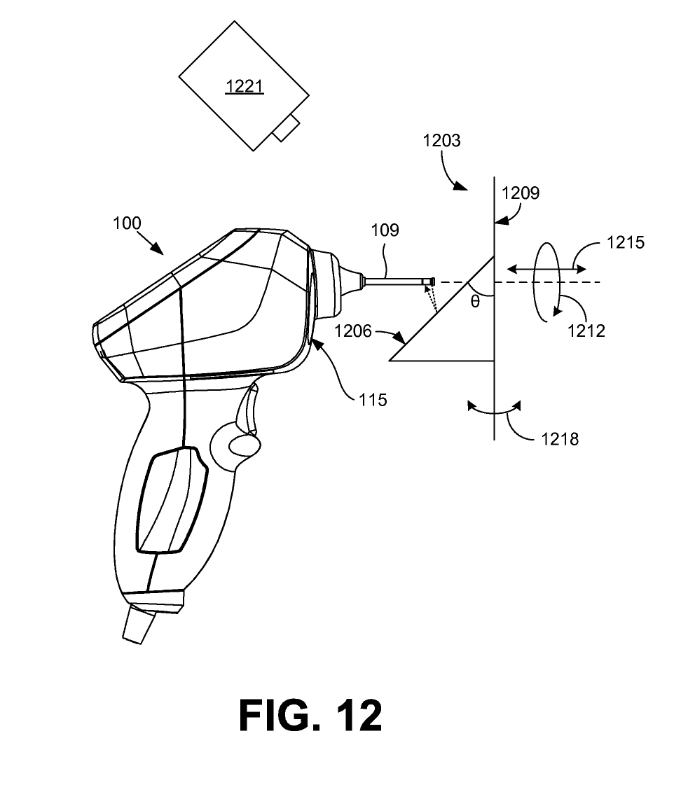

Calibration of the lens system 1133 of the probe 109 may be carried out using a calibration target 1203 including a calibration pattern such as, e.g., the patterns illustrated in FIGS. 9B and 9C. For instance, the calibration target 1203 may include a grid pattern 912 as the calibration pattern that is surrounded by a fiducial marker 403 for orientation by the tracking system. In some implementations, the plane 1206 of the calibration pattern may be tipped at a predefined angle (θ) with respect to the plane 1209 of the fiducial marker as shown in FIG. 12. The predefined angle (θ) may be 45°, 60° or other angle suitable for illumination by light that is radially reflected at the probe tip 1115 as shown in FIG. 11C or projected from a fan light element 112 as shown in FIG. 2.

When the calibration target 1203 is aligned with the probe 109 of the scanning device 100 as depicted in FIG. 12, the plane 1209 of the fiducial marker 403 is substantially perpendicular to the probe 109 and the plane 1206 of the calibration pattern extends along one side of the probe 109. Such an alignment can aid the tracking system in identifying the orientation of the calibration target 1203 with respect to the probe 109. The calibration target 1203 may be rotated 1212 about the longitudinal axis of the probe 109, translated 1215 towards or away from the tip of the probe 109, and/or tilted 1218 with respect to the plane of the probe 109. Rotation 1212 allows for a 360° calibration around the probe 109, translation 1215 allows for calibration at different distances, and tilting 1218 allows for adjustment of the calibration pattern plane 1206 with respect to the probe 109.

In other embodiments, the grid pattern 912 may be coplanar with the fiducial marker 403 as illustrated in FIG. 9C. With a coplanar calibration target, both the calibration pattern (e.g., the grid pattern 912 or dot pattern 909) and the fiducial marker 403 are in the same plane 1209. The coplanar calibration target may be tipped 1218 to allow the calibration pattern to extend along one side of the probe 109. The tracking system can use the fiducial markers of the coplanar calibration target to determine orientation of the calibration target and calibration pattern. Calibration of the lens system 1133 of the probe 109 will be discussed with respect to the calibration target 1203 of FIG. 12; however calibration of the lens system 1133 of the probe 109 may be carried out in a similar fashion using a tilted coplanar calibration target.

For calibration, the scanning device 100 may be held in a fixed orientation and position by a cradle, clamp, or other appropriate apparatus and the rotation 1212, translation 1215 and/or tilting 1218 of the calibration target 1203 may be accomplished using mechanical linkages that are controlled by a controller, computing device, or other control device (not shown). For example, a robotic arm may be used to accurately position the calibration target 1203 with respect to the probe 109 during calibration. A calibration control system may be used to control the robotic arm (or other mechanical linkage) for positioning and/or orientation of the calibration target 1203. The calibration control system may also be communicative coupled to the scanning device 100 to acquire, monitor and/or process calibration data obtained by the scanning device 100. One or more external camera(s) 1221 may be used to provide feedback for positioning and orientation of the calibration target 1203. In alternative implementations, the orientation and/or position of the scanning device 100 may be adjusted by rotating, translating and/or tilting, while the calibration target is held in a fixed position.

After a calibration pattern such as the grid pattern 912 has been oriented with respect to the probe 109, calibration may be carried out by rotating 1212 and/or translating 1215 the calibration target 1203 with respect to the probe 109. Initially, the grid pattern 912 is illuminated by the light that is radially reflected by the cone mirror 1121 at the probe tip 1115 as illustrated in FIG. 11B. Based on the position of the calibration target 1203, a portion of the radially transmitted light may be reflected from the grid pattern 912 back to the probe 109, where the lens system 1133 captures and directs the reflected light onto the image sensor 1136 as shown in FIG. 11B. Pixel information such as a brightness value is then obtained for each pixel of the image sensor 1136.

The tracking position of the fiducial marker 403, and thus the grid pattern 912, can be concurrently determined using the tracking sensors 115 as previously discussed. The location in scanner space of the reflection from the grid pattern 912 can also be determined using the tracking sensors 115. In some implementations, one or more external camera(s) 1221 may be used to determine the location of the reflection from the grid pattern 912. By rotating 1212 the calibration target 1203 about the probe 109, pixel information for a 360° view can be obtained. Translation 1215 of the calibration target 1203 allows for the capture of depth information by moving the grid pattern 912 closer or further from the probe tip. The calibration target 1203 may be incrementally repositioned during acquisition of the pixel information for calibration.

The correspondence between the pixels and points in scanner space can be established using triangulation as discussed and illustrated with respect to FIG. 8. A three dimensional (3D) curve fit may then be used to map the relationship between the pixels and the scanner space. For example, 3D interpolation can be used to produce, e.g., a fourth-order 3D curve fit from the gathered pixel information. In this way, the 3D position of the reflected light relative to the fiducial marker 403 can be established for every pixel in the image sensor 1136. The association between a pixel of the image sensor 1136 and a point in scanner space can be stored as a record in a lookup table for easy access and processing during image construction. Using such stored associations between pixels and points in scanner space, the process of transforming ridge points to points in scanner space is carried out with table lookups and the like rather than real time triangulations.

In addition to the 3D mapping of the pixel information, the location of the cone mirror 1121 can be established during the initial calibration of the scanning device 100. The cone mirror 1121 located at the distal end of the probe 109 shows up as a dark ring during image capture by the image sensor 1136. One or more images can be captured after calibration of the lens system 1133 of the probe 109 and the centroid of the ring determined and saved for later comparison. As the most likely cause for the probe to go out of calibration is deformation of the probe 109, comparing the centroid of a current image (or images) of the cone mirror 1121 to the centroid of the calibration image provides a quick verification of the probe condition. By comparing the centroid of the cone mirror 1121, the calibration of the probe 109 can be verified while the scanning device 100 is in the calibration cradle 1000 of FIGS. 10A and 10B.

In other implementations, the calibration cradle 1000 may include a calibration target 1203 positioned adjacent to the inner surface 1006 of the calibration cradle 1000 of FIG. 10A. The calibration cradle 1000 may be configured to control the position of the calibration target 1203. When the scanning device 100 is positioned within the recesses 1003, the tracking sensors 115 and probe 109 of the scanning device 100 face the calibration target 1203 as depicted in FIG. 12. The recesses 1003 hold the scanning device 100 at a fixed position with respect to the calibration target 1203. Positioning pins may be included in the recesses 1003 of the calibration cradle 1000 to hold the scanning device 100 within a known tolerance of the calibration target 1203. Control circuitry associated with the calibration cradle 1000 can reposition the calibration target 1203 for calibration of the lens system 1133 of the probe. As discussed above, the calibration target 1203 may be rotated 1212 about the longitudinal axis of the probe 109 and/or translated 1215 towards or away from the tip of the probe 109.

With the scanning device 100 positioned in the calibration cradle 1000, calibration of the lens system 1133 of the probe 109 can be verified and/or adjusted using the calibration target 1203. Calibration may be carried out by rotating 1212 and/or translating 1215 the calibration target 1203 through a series of positions with respect to the probe 109. At each position, the calibration pattern may be illuminated by light that is radially reflected from the tip of the probe 109. Based on the position of the calibration target 1203, a portion of the radially transmitted light is reflected from the calibration pattern and captured by the image sensor 1136 via the lens system 1133. Using the lookup table, the pixel information can be transformed into a scanner space location. The tracking sensors 115 can be used to concurrently determine the orientation of the calibration target 1203 using the fiducial marker 403 and/or the location of the reflection from the calibration pattern. The two locations may then be compared to verify that the calibration of the lens system 1133 of the probe 109 is within a predefined tolerance. The calibration target 1203 may be incrementally repositioned in a plurality of positions during acquisition of the pixel information to verify the calibration. If the calibration is out of tolerance, the calibration target 1203 and tracking sensors 115 may be used to adjust the lookup table values as discussed above.

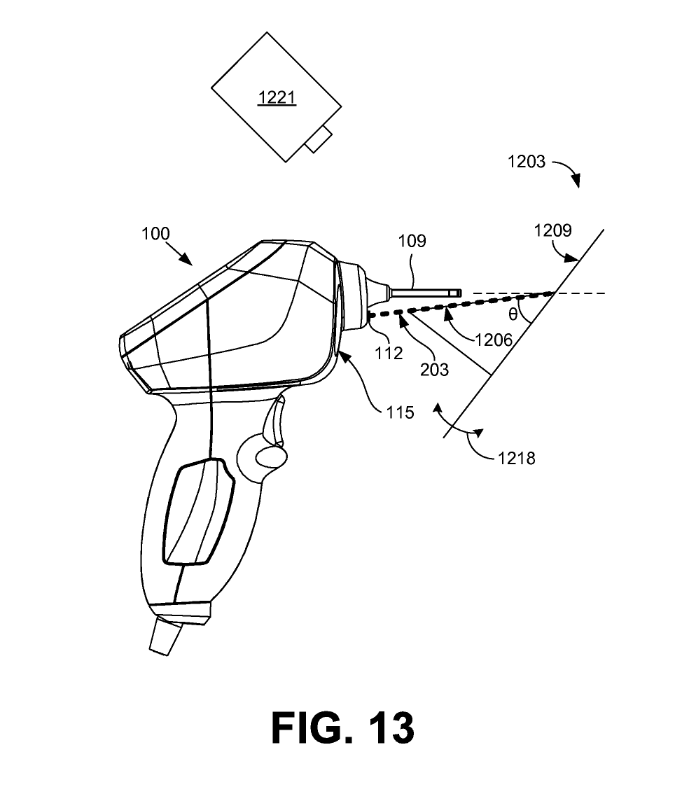

Referring next to FIG. 13, shown is an example of calibration of a fan line 203 for 3D reconstruction using the calibration target 1203 of FIG. 12. As shown in FIG. 13, the fan light element 112 mounted on the scanning device 100 emits collimated light in a fan line under the probe 109. As shown in the example of FIG. 13, the fan line 203 is projected at a fixed angle with respect to the probe 109. In some implementations, the fan line 203 may be substantially parallel with the probe 1303. For calibration, the calibration target is tilted 1218 so that the plane 1206 of the calibration pattern is substantially coplanar with plane of the fan line 203. Images of the illuminated calibration pattern are then obtained by the image sensor 1136 via the lens system 1133 (FIG. 11B) to obtain pixel information. While the calibration pattern is identified, the tracking position of the fiducial marker 403 is concurrently determined using the tracking sensors 115. In some implementations, one or more external camera(s) 1221 may be used to determine the location of the reflections from the calibration pattern. As with the probe lens system calibration, a three dimensional (3D) curve fit may then be used to map the relationship between the pixels and the scanner space. Interpolation using the pixel information can be used to generate a lookup table that defines the 3D position of the fan line 203 in scanner space for every pixel in the image sensor 1136. By using triangulation of the reflections captured when the fan line 203 is projected onto a surface, the imaging system within the scanning device 100 may reconstruct a three-dimensional (3D) image of the scanned surface.

Calibration of the fan line 203 may be verified using the calibration cradle 1000 of FIGS. 10A and 10B. For example, with the scanning device 100 positioned in the calibration cradle 1000, the fan line 203 may be projected onto a calibration pattern on the inner surface 1006 of the calibration cradle 1000. The calibration pattern may include, e.g., a grid pattern, an oscillating or saw tooth line, or other appropriate pattern along a portion of the inner surface 1006. When the fan line 203 is projected onto the pattern, pixel information may be acquired and used to determine the location of the calibration pattern in scanner space. The tracking sensors 115 can be used to concurrently determine the location of the reflections from the calibration pattern. The locations may then be compared to verify that the calibration of the fan line 203 is within a predefined tolerance. In other implementations, the location of the fan line 203 may be determined from the pixel information and compared to a defined location that is based upon the fixed position of the scanning device 100 with respect to the calibration pattern.

Where the calibration cradle includes a calibration target 1203, the calibration of the fan line 203 may also be verified by projecting the fan line 203 onto the calibration pattern of the calibration target 1203. The tracking sensors 115 can be used to concurrently determine the location of the reflections from the calibration pattern, which can be compared to verify that the calibration of the fan line 203. In some cases, the calibration target 1203 may be used to calibrate the fan line 203 while the scanning device 100 is seated in the calibration cradle 1000. Control circuitry associated with the calibration cradle 1000 may reposition the calibration target 1203 for calibration of the fan line 203 by rotating 1212, translating 1215, and/or tilting 1218 the calibration target 1203 to substantially align the plane 1206 of the calibration pattern with the plane of the fan line 203. For example, the calibration target 1203 may be oriented to place the plane 1206 of the calibration pattern in a predefined position that is substantially coplanar with the plane of the fan line 203 when the scanning device 100 is seated in the recesses 1003 of the calibration cradle 1000. With the calibration pattern illuminated by the fan light 1303, calibration of the fan light 1303 may be performed as discussed above.

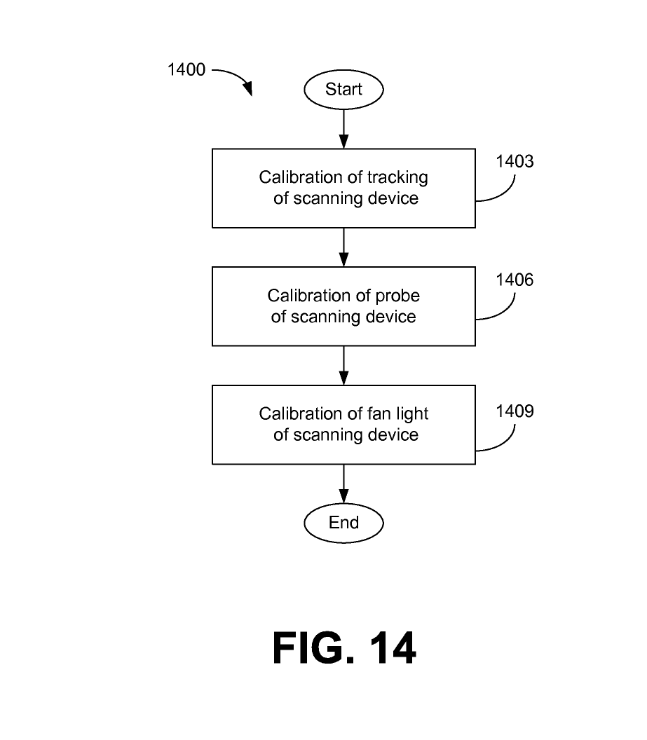

Referring next to FIG. 14, shown is a flow chart 1400 illustrating an example of calibration of the scanning device 100 of FIGS. 1A-1C. Beginning with 1403, calibration of the tracking using the tracking sensors 115 of the scanning device 100 (FIG. 1A-1C) can be performed. After calibration of the tracking system is complete, the lens system 1133 of the probe 109 (FIG. 11B) of the scanning device 100 can be performed at 1406. Calibration of the fan line 203 (FIG. 2) may be performed at 1409. The flow chart 1400 of FIG. 14 may also illustrate verification of the scanning device calibration. Verification of the tracking calibration using the tracking sensors 115 can be performed at 1403 and the probe calibration can be verified at 1406. At 1409, calibration of the fan line may be verified.

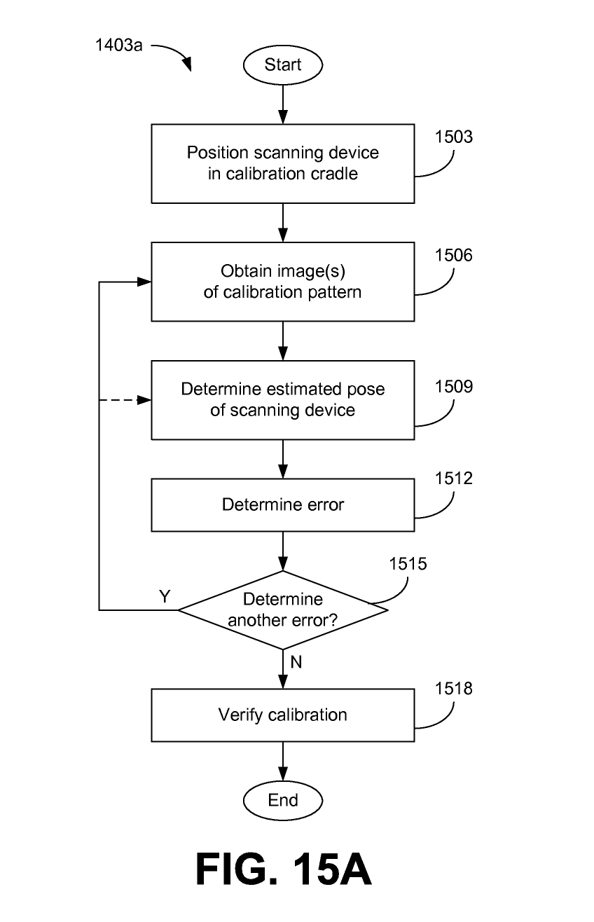

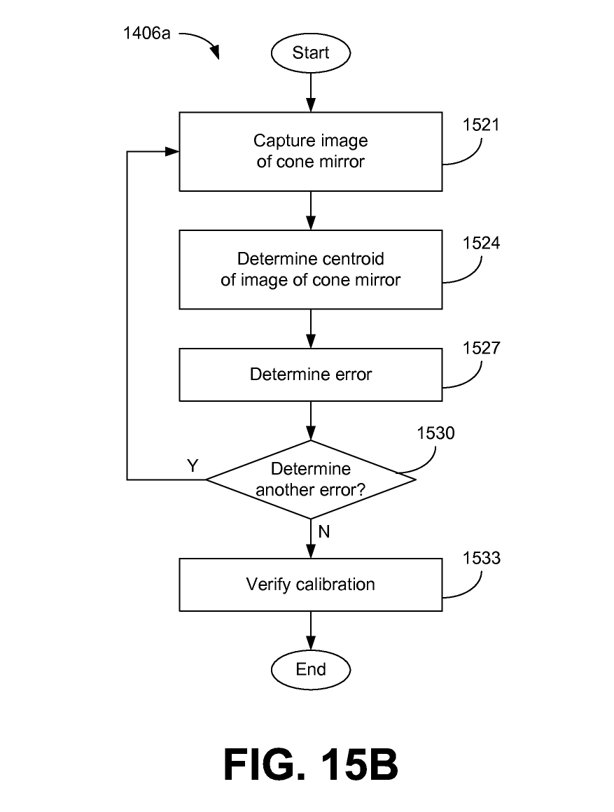

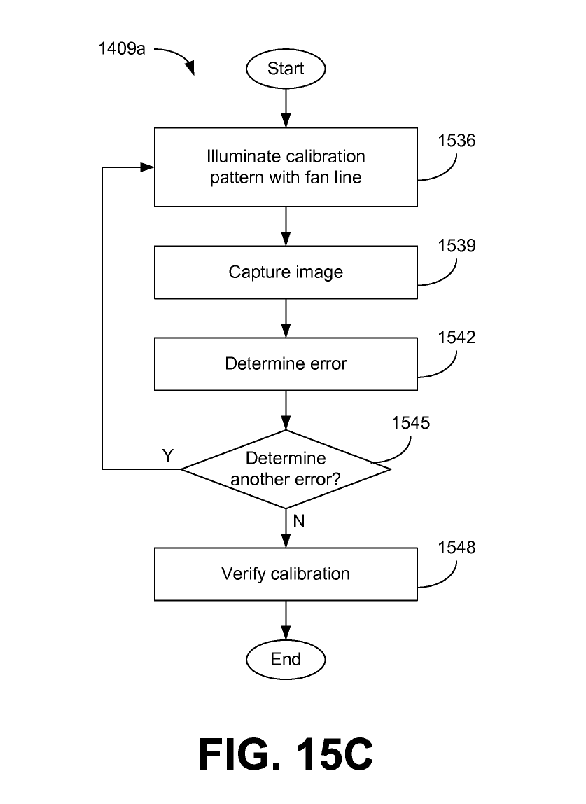

FIG. 15A shows a flow chart 1403a illustrating an example of verification of the tracking calibration using the calibration cradle 1000 of FIGS. 10A and 10B. Beginning with 1503, the scanning device 100 is positioned within the calibration cradle 1000. As previously discussed, the calibration cradle 1000 includes recesses 1003 that are configured to receive and hold the scanning device 1000 in a fixed position relative to a calibration pattern. The calibration pattern includes artifacts such as dots, squares or other shapes distributed in a known pattern. For example, the calibration pattern can be a dot pattern or grid pattern as illustrated in FIGS. 9A-9C. The calibration pattern can be affixed to an inner surface 1006 of the calibration cradle 1000 (FIG. 10A) or can be part of a calibration target 1203 (FIG. 12) located within the calibration cradle 1000.

At 1506, one or more images of the calibration pattern is obtained with the tracking sensors 115 (FIGS. 1A-1C) of the scanning device 100. The images may be captured with the scanning device positioned in the calibration cradle 1000 or may be captured as the scanning device 1000 is being positioned in the calibration cradle 1000. By capturing images as the scanning device 100 is being inserted into the calibration cradle 1000, calibration of the tracking may be verified at various distances between the tracking sensors 115 and the calibration pattern. Image capture may be initiated and/or controlled using the trigger 121 or display screen 118 of the scanning device 100 or through a separate control interface communicatively coupled to the scanning device 100.

The pose of the scanning device is estimated in 1509 based upon the images captured by the tracking sensors 115. The pose of the scanning device 100 may be estimated based upon the calibration pattern and/or a fiducial marker located adjacent to at least a portion of the calibration pattern. For example, a calibration pattern may include a central reference mark with, e.g., special markings or dots in the center of tracking sensor viewing area to assist in identification of the origin and orientation of the x-axis and y-axis of the pattern. In other implementations, the fiducial marker may be used to estimate the pose of the scanning device 100.

At 1512, an error is determined based upon the estimated pose of the scanning device 100. For example, an error between the location of an artifact of the calibration pattern based upon the image of the calibration pattern and a projected location of the artifact based upon the estimated pose of the scanning device with respect to the calibration pattern. Since the calibration pattern is known, one or more artifacts (e.g., a dot in a dot pattern) may be projected out to the place of the calibration pattern using the estimated pose. The projected location of the artifact can be compared to the actual location of the artifact in the captured image to determine the error value.

If another error is to be determined in 1515, then the flow may return to 1506 to obtain another image of the calibration pattern. If a plurality of images were initially captured in 1506, then the flow can return to 1509 to determine an estimated pose of the scanning device 100 based on the next image or set of captured images. A plurality of errors corresponding to the different images or sets of images may be determined in this way. For example, a predefined number of errors (e.g., three) may be determined for calibration verification of the tracking. If no other errors are to be determined in 1515, then the calibration is verified in 1518 based upon the determined error(s). For multiple errors, a median error may be determined from the errors and compared to a predefined threshold such as, e.g., 0.025 mm, 0.050 mm, or other appropriate calibration tolerance.

A calibration error indication may be provided to the user of the scanning device 100 in response to the error comparison. The calibration error indication (e.g., successful test of tracker, tracker calibration error or out-of-calibration, unable to perform (or complete) error test, etc.) may be displayed on the display screen 118 of the scanning device 100 and/or other displays in data communication with the scanning device 100. The calibration error indication may also indicate when the error test cannot be performed such as, e.g., when an image of the calibration pattern cannot be acquired. In other embodiments, an indicator light may provide the calibration error indication. In some implementations, an indication of a tracker calibration error may automatically initiate calibration of the tracking.

Referring now to FIG. 15B, shown is a flow chart 1406a illustrating an example of verification of the probe calibration. Beginning with 1521, an image of the cone mirror 1121 (FIG. 11B) located at a distal end of the probe 109 of a scanning device 100 is captured using the image sensor 1136 located at a proximal end of the probe 109. The imaged may be processed to identify the ring produced by the cone mirror 1121. In 1524, the centroid of the captured image of the cone mirror (i.e., the ring) is determined. An error may then be determined in 1527 by, e.g., comparing the centroid of the captured image of the cone mirror 1121 and a reference centroid of the cone mirror 1121 that was previously captured during calibration of the probe 109.

If another error is to be determined in 1530, then the flow may return to 1521 to obtain another image of the cone mirror 1121. A plurality of errors corresponding to the different images may be determined in this way. For example, a predefined number of errors (e.g., three) may be determined for calibration verification of the probe 109. If no other errors are to be determined in 1530, then the calibration is verified in 1533 based upon the determined error(s). For multiple errors, a median error may be determined from the errors and compared to a predefined threshold such as, e.g., 5 pixels or other appropriate calibration tolerance.

A calibration error indication may be provided to the user of the scanning device 100 in response to the error comparison. The calibration error indication (e.g., successful test of probe, probe or lens calibration error or out-of-calibration, unable to perform (or complete) error test, etc.) may be displayed on the display screen 118 of the scanning device 100 and/or other displays in data communication with the scanning device 100. In other embodiments, an indicator light may provide the calibration error indication. In some cases, a single calibration indication may be provided for both the tracker and probe calibration verifications. In some implementations, an indication of a probe calibration error may automatically initiate calibration of the lens system 1133 of the probe 109.

Referring now to FIG. 15C, shown is a flow chart 1409a illustrating an example of verification of the fan line calibration using the calibration cradle 1000 of FIGS. 10A and 10B. With the scanning device 100 in a fixed position within the calibration cradle 1000, the calibration pattern is illuminated with the fan line 203 (FIG. 2) in 1536 and an image of the reflections from the calibration pattern is captured by the image sensor 1136 in 1539. Because of the fixed relationship between the scanning device 100 and the calibration pattern, a predefined location of the fan light projection in the calibration cradle 1000 may be used to determine an error in 1542. In other implementations, the tracking sensors also capture images of the fan light 203 in 1539 and use the captured images to determine the position of the fan light 203. The error may be determined in 1542 by comparing the location of the fan light 203 based upon the pixel information captured by the image sensor 1136 and the location of the fan light 203 based upon the tracking sensors 115.

If another error is to be determined in 1545, then the flow may return to 1536 to illuminate the calibration pattern and capture another image in 1539. A plurality of errors corresponding to the different images may be determined in this way. For example, a predefined number of errors (e.g., three) may be determined for calibration verification of the fan line 203. If no other errors are to be determined in 1545, then the calibration is verified in 1548 based upon the determined error(s) and a calibration error indication may be provided in response to the error comparison. For multiple errors, a median error may be determined from the errors and compared to a predefined threshold such as, e.g., 0.025 mm, 0.050 mm or other appropriate calibration tolerance.

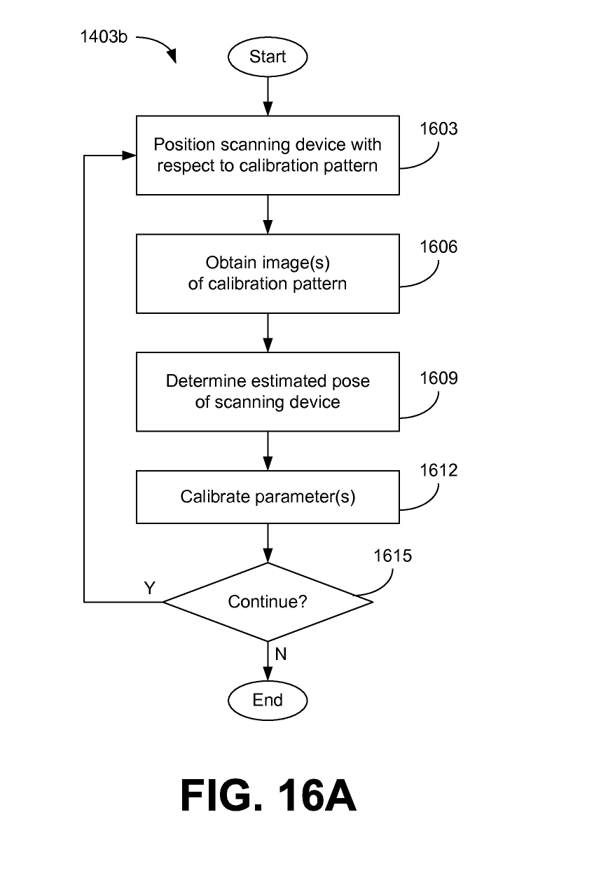

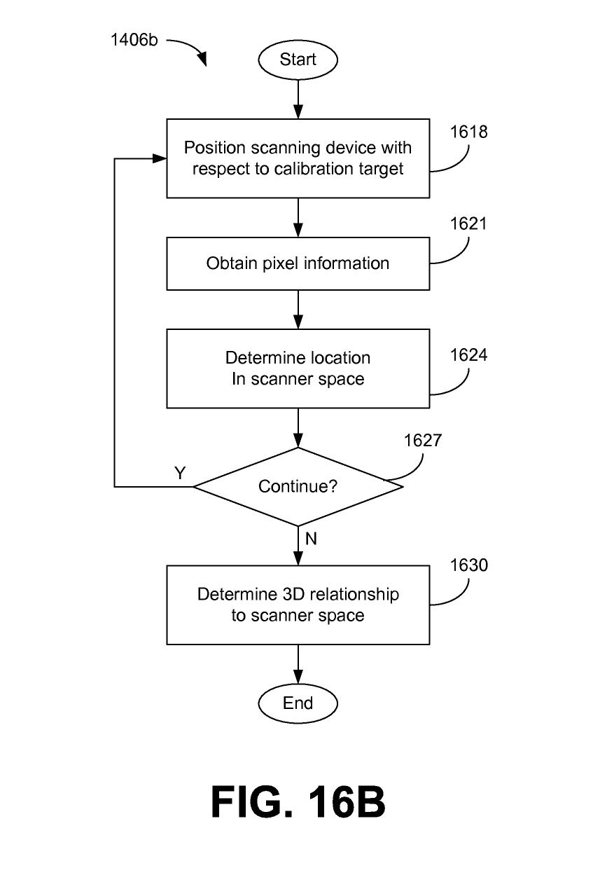

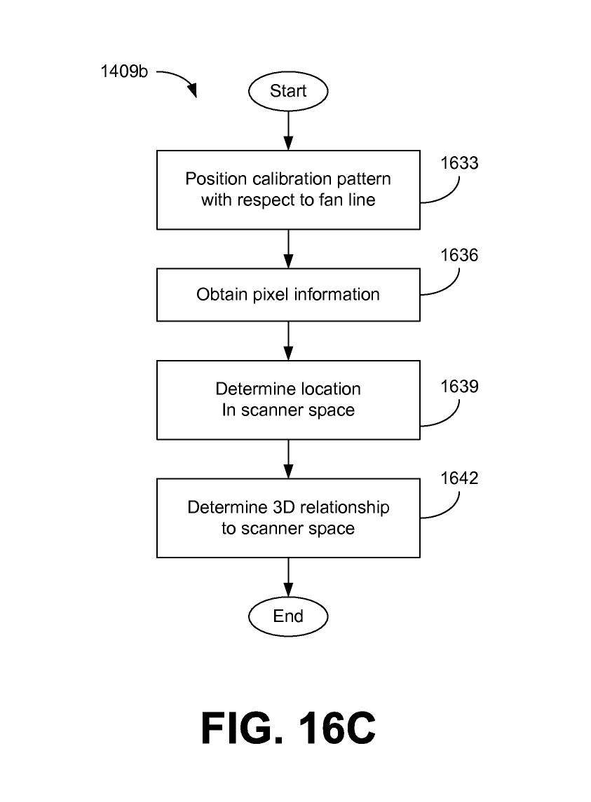

Moving to FIG. 16A, shown is a flow chart 1403b illustrating an example of calibration of the tracking of the scanning device 100. Beginning with 1603, the scanning device 100 is positioned with respect to a calibration pattern such as, e.g., the calibration patterns illustrated in FIGS. 9A-9C. In 1606, one or more images of the calibration pattern are obtained using the tracking sensors 115 (FIG. 5) of the scanning device 100. An estimated pose of the scanning device 100 may then be determined in 1609 based on the images. Initially, orientation of the calibration pattern is determined. For example, a central reference mark included in the calibration pattern or a fiducial marker adjacent to the calibration pattern may be used to identify orientation of the calibration pattern. A set of artifacts (e.g., dots of a dot pattern or squares of a grid pattern) of the calibration pattern may then be used to determine an estimated pose of the scanning device 100.

Calibration of the tracking parameters may then be performed in 1612 using the estimated pose of the scanning device 100. Using the estimated pose and the current tracking parameters, the location of another set of artifacts of the calibration pattern are projected out to the plane of the calibration pattern. The difference between the projected location and the actual location of the dots of the calibration pattern (which can be determined from the captured images of the calibration pattern) are used as errors to adjust the tracking parameters. In this way, a gradient dissent algorithm may be used to calibrate the parameters to minimize the errors between the projected and actual locations. For example, an error may be considered minimized when reduced to below a predefined threshold.

At 1615, it is determined whether additional calibration is to be performed. For example, calibrating the tracking parameters with the calibration pattern located at different distances from the tracking sensors 115 can improve tracking results. If additional calibration is to be performed, then the flow returns to 1603 where position of the scanning device 100 with respect to the calibration pattern is modified. For example, a robotic control may be used to reposition the scanning device 100 and/or a calibration pattern. In some embodiments, calibration pattern may be moved through a series of predefined locations as the images are captured in 1606.

After calibration of the tracking is completed, calibration of the probe 109 may be carried out. Referring now to FIG. 16B, shown is a flow chart 1406b illustrating an example of calibration of the probe 109. At 1618, the scanning device 100 is positioned with respect to a calibration target such that a calibration pattern is positioned along one side of the probe 109 of the scanning device 100. In the example of FIG. 12, the calibration target 1203 is aligned such that the plane 1209 of the fiducial marker 403 is substantially perpendicular to the probe 109 and the plane 1206 of the calibration pattern extends along one side of the probe 109. The calibration target 1203 may be rotated 1212 about the longitudinal axis of the probe 109, translated 1215 towards or away from the tip of the probe 109, and/or tilted 1218 with respect to the plane of the probe 109. In some implementations, the scanning device 100 is held in a fixed orientation and position by a cradle, clamp, or other appropriate apparatus and the position of the calibration target 1203 is adjusted. In other implementations, the position of the scanning device is adjusted while the calibration target is held in a fixed position.

At 1621, pixel information obtained with the image sensor 1136 via the lens system 1133. With the calibration pattern positioned along one side of the probe 109, the calibration pattern is illuminated by light that is radially reflected at a distal end of probe 109 by the cone mirror 1121 (FIG. 11B). The lens system 1133 captures and directs the light reflected from the calibration pattern onto the image sensor 1136 (FIG. 11B). Pixel information such as, e.g., brightness is then obtained for each pixel of the image sensor 1136. The location of the reflected light is determined at 1624. For example, the actual location of the reflection may be estimated based upon images of the calibration pattern during illumination that is obtained using the tracking sensors 115. Triangulation can be used to estimate the actual location of the reflection. In other implementations, images may be obtained using one or more external cameras or a combination of tracking sensor(s) and external camera(s). The pose of the scanning device 100 with respect to the calibration pattern may be determined using the tracking sensors 115 and used to estimate the location of the reflected light. For example, the pose of the scanning device 100 may be determined based upon the calibration pattern and/or a fiducial marker adjacent to (or surrounding) the calibration pattern. The known relationship between the calibration pattern and fiducial marker can be used to estimate the reflection location. The estimate of the reflection location can be concurrently determined at 1624 while pixel information is obtained in 1621.

At 1627, it is determined whether additional pixel information should be obtained. If it is determined to continue obtaining additional pixel information, then the flow can return to 1618 where the calibration target can be repositioned to obtain the pixel information at 1621 and scanning device pose at 1624. For example, pixel information can be obtained with the calibration pattern in a plurality of positions. By rotating the calibration target about the probe 109, pixel information for a 360° view can be obtained. Translation of the calibration target allows for the capture of depth information by moving the calibration pattern closer or further from the probe tip.

If not, then an association between a pixel of the image sensor and a point in scanner space is determined at 1630. The 3D relationship to scanner space can be based at least in part upon the pixel information associated with the plurality of locations. A 3D-curve fit can be used to map the relationship between the pixels and the scanner space. For example, 3D interpolation can be used to produce, e.g., a fourth-order 3D curve fit from the gathered pixel information. The association between a pixel of the image sensor 1136 and a point in scanner space can be stored as a record in a lookup table for easy access and processing during image construction.

Referring now to FIG. 16C, shown is a flow chart 1409b illustrating an example of calibration of the fan line using a calibration pattern. Beginning with 1633, the calibration pattern is positioned with respect to the fan line 203 (FIG. 13) such that the calibration pattern is substantially coplanar with the fan line 203. For example, a calibration target 1203 including a calibration target may be positioned to align the plane 1206 of the calibration pattern and the fan line 203 as shown in FIG. 13.

At 1636, pixel information is obtained for the fan line 203. With the calibration pattern substantially planar to the fan light 203, the calibration pattern is illuminated with the fan line 203. Pixel information associated with the reflections from the calibration pattern is captured by the image sensor 1136 via the lens system 1133. The location of the reflected light is determined at 1639. For example, the actual location of the reflection may be estimated based upon images of the calibration pattern during illumination that are obtained using the tracking sensors 115. Triangulation can be used to estimate the actual location of the reflection. In other implementations, images may be obtained using one or more external cameras or a combination of tracking sensor(s) and external camera(s). The pose of the scanning device 100 with respect to the calibration pattern may be determined using the tracking sensors 115 and used to estimate the location of the reflected light. For example, the pose of the scanning device 100 may be determined based upon the calibration pattern and/or a fiducial marker adjacent to (or surrounding) the calibration pattern. The known relationship between the calibration pattern and fiducial marker can be used to estimate the reflection location. The estimate of the reflection location can be concurrently determined at 1639 while pixel information is obtained in 1636.

At 1642, the 3D relationship between pixels of the image sensor 1136 and scanner space can be based at least in part upon the pixel information. A 3D-curve fit can be used to map the relationship between the pixels and the scanner space. The association between a pixel of the image sensor 1136 and a point in scanner space can be stored as a record in a lookup table for easy access and processing during image construction.

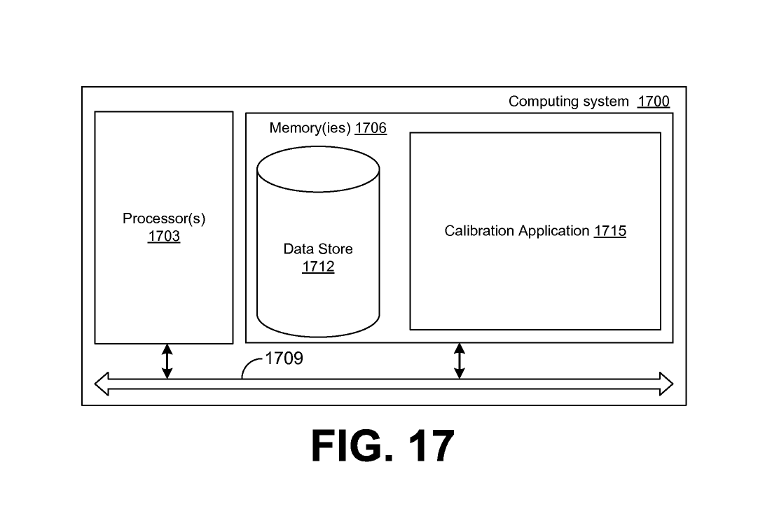

With reference to FIG. 17, shown is a schematic block diagram of a computing system 1700 according to an embodiment of the present disclosure. A computing system 1700 may comprise at least one processor circuit or processing circuitry, for example, having a processor 1703 and a memory 1706, both of which are coupled to a local interface 1709. The local interface 1709 may comprise, for example, a data bus with an accompanying address/control bus or other bus structure as can be appreciated. In some embodiments, the computing system 1700 may be included in the scanning device 100 (FIGS. 1A-1C), an calibration control system, an external computing device, or distributed between a combination thereof.

Stored in the memory 1706 are both data and several components that are executable by the processor 1703. In particular, a calibration application 1715 is stored in the memory 1706 and executable by the processor 1703, as well as other applications. Also stored in the memory 1706 may be a data store 1712 and other data. In addition, an operating system may be stored in the memory 1706 and executable by the processor 1703.

It is understood that there may be other applications that are stored in the memory 1706 and are executable by the processor 1703 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1706 and are executable by the processor 1703. In this respect, the term “executable” means a program file that is in a form that can ultimately be run by the processor 1703. Examples of executable programs may be, for example, a compiled program that can be translated into machine code in a format that can be loaded into a random access portion of the memory 1706 and run by the processor 1703, source code that may be expressed in proper format such as object code that is capable of being loaded into a random access portion of the memory 1706 and executed by the processor 1703, or source code that may be interpreted by another executable program to generate instructions in a random access portion of the memory 1706 to be executed by the processor 1703, etc. An executable program may be stored in any portion or component of the memory 1006 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 1706 is defined herein as including both volatile and nonvolatile memory and data storage components. Volatile components are those that do not retain data values upon loss of power. Nonvolatile components are those that retain data upon a loss of power. Thus, the memory 1706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1703 may represent multiple processors 1703 and/or multiple processor cores and the memory 1706 may represent multiple memories 1706 that operate in parallel processing circuits, respectively. In such a case, the local interface 1709 may be an appropriate network that facilitates communication between any two of the multiple processors 1703, between any processor 1703 and any of the memories 1706, or between any two of the memories 1706, etc. The local interface 1709 may comprise additional systems designed to coordinate this communication, including, for example, performing load balancing. The processor 1003 may be of electrical or of some other available construction.

Although the calibration application 1715, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 14, 15A-15C and 16A-16C show various functionality and operation of an implementation of portions of the calibration application 1715. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1703 in a computer system or other system. The machine code may be converted from the source code, etc. If embodied in hardware, each block may represent a circuit or a number of interconnected circuits to implement the specified logical function(s).

Although the flowchart of FIGS. 14, 15A-15C and 16A-16C show a specific order of execution, it is understood that the order of execution may differ from that which is depicted. For example, the order of execution of two or more blocks may be scrambled relative to the order shown. Also, two or more blocks shown in succession in FIGS. 14, 15A-15C and 16A-16C may be executed concurrently or with partial concurrence. Further, in some embodiments, one or more of the blocks shown in FIGS. 14, 15A-15C and 16A-16C may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the calibration application 1715, that comprises software or code can be embodied in any non-transitory computer-readable medium for use by or in connection with an instruction execution system such as, for example, a processor 1703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the calibration application 1715, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the scanning device 100, the calibration control system or in multiple computing devices in a common computing environment. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A system, comprising:
a calibration target including a calibration pattern;
a sensing device comprising tracking sensors; and
a calibration control system configured to control positioning of the calibration pattern with respect to the sensing device, where the tracking sensors capture images of the calibration pattern at a plurality of positions during calibration of the sensing device.

2. The system of claim 1, wherein the sensing device is held in a fixed position and the position of the calibration target is varied by the calibration control system with respect to the sensing device.

3. The system of claim 2, wherein the calibration target is positioned by a robotic arm controlled by the calibration control system.

4. The system of claim 2, further comprising a cradle that holds the sensing device in the fixed position.

5. The system of claim 1, wherein the calibration control system is further configured to determine an estimated pose of the scanning device with respect to the calibration pattern based upon one or more images of the calibration pattern captured by the tracking sensors at one position of the plurality of positions.

6. The system of claim 5, wherein the calibration control system is further configured to:
determine a projected location of an artifact of the calibration pattern based at least in part upon the estimated pose of the scanning device; and
determine an error between the projected location of the artifact and an actual location of the artifact.

7. The system of claim 6, wherein the actual location is based upon the one or more images captured at the one position.

8. The system of claim 6, wherein the calibration control system is further configured to:
determine a plurality of errors based upon projected locations and actual locations of a plurality of artifacts of the calibration pattern; and
adjust a tracking parameter based at least in part upon the plurality of errors.

9. The system of claim 6, wherein the artifact is a square of a grid pattern.

10. The system of claim 1, wherein the images are captured by the tracking sensors at a plurality of distances from the calibration pattern.

11. The system of claim 1, wherein the sensing device further comprises a probe configured to radially project light from a distal of the probe and an image sensor at a proximal end of the probe;
wherein the calibration control system is further configured to control positioning of the calibration pattern with respect to the tip of the probe.

12. The system of claim 11, wherein the calibration control system is further configured to:
initiate radial projection of the light onto the calibration pattern;
obtain, from the image sensor, pixel information corresponding to light reflected by the calibration pattern; and
determine an association between a pixel of the image sensor and a point in scanner space based at least in part upon the pixel information.

13. The system of claim 12, wherein the association between the pixel of the image sensor and the point in scanner space is based at least in part upon pixel information obtained with the calibration pattern positioned in a plurality of locations about the tip of the probe.

14. A method, comprising:
obtaining an image of a calibration pattern with a tracking sensor of a scanning device;
determining an estimated pose of the scanning device based at least in part upon the image of the calibration pattern;
determining an error between a projected location of an artifact of the calibration pattern based upon the estimated pose of the scanning device and an actual location of the artifact; and
adjusting a tracking parameter based at least in part upon the error.

15. The method of claim 14, further comprising positioning the calibration pattern of artifacts with respect to the scanning device.

16. The method of claim 14, wherein the actual location of the artifact is based upon the image of the calibration pattern.

17. The method of claim 14, comprising:
determining a plurality of errors based upon projected locations and actual locations of a plurality of artifacts of the calibration pattern; and
adjusting the tracking parameter based at least in part upon the plurality of errors.

18. The method of claim 17, wherein a gradient dissent algorithm is used to adjust the parameters based upon the plurality of errors.

19. The method of claim 14, comprising obtaining a plurality of images with tracking sensors of the scanning device.

20. The method of claim 19, wherein the images are obtained with the tracking sensors at a plurality of distances from the calibration pattern.

21. A method, comprising:
illuminating a calibration pattern with light radially projected from a tip of a probe of a scanning device;
obtaining, from an image sensor of the scanning device, pixel information corresponding to light reflected by the calibration pattern; and
determining an association between a pixel of the image sensor and a point in scanner space based at least in part upon the pixel information.

22. The method of claim 21, further comprising positioning a calibration target including the calibration pattern with respect to the tip of the probe.

23. The method of claim 21, comprising:
positioning the calibration target at a plurality of locations with respect to the tip of the probe;
obtaining pixel information corresponding to light reflected by the calibration pattern at the plurality of locations; and
determining the association between the pixel of the image sensor and the point in scanner space based at least in part upon the pixel information associated with the plurality of locations.

24. The method of claim 23, wherein the association between the pixel of the image sensor and the point in scanner space is based upon a three dimensional (3D) curve fit using the pixel information associated with the plurality of locations.

25. The method of claim 23, further comprising determining estimated locations of the light reflected by the calibration pattern, wherein the association between the pixel of the image sensor and the point in scanner space based at least in part upon the estimated locations.

26. The method of claim 21, further comprising determining an estimated location of the light reflected by the calibration pattern, wherein the association between the pixel of the image sensor and the point in scanner space based at least in part upon the estimated location.

27. The method of claim 26, further comprising determining a pose of the scanning device, wherein the estimated location of the light reflected by the calibration pattern is based at least in part upon the pose.

28. The method of claim 27, wherein the pose is determined based upon a fiducial marker on the calibration target.

29. The method of claim 28, further comprising obtaining images of the fiducial marker with tracking sensors of the scanning device.

30. The method of claim 27, wherein the estimated pose is determined from an image of the calibration pattern.
